(19) United States
(12) Patent Application Publication
(10) Pub. No.: US 2023/0185118 A1
(43) Pub. Date: Jun. 15, 2023

(54) OPTICAL DEVICE AND OPTICAL DETECTION SYSTEM

(71) Applicant: Panasonic Intellectual Property Management Co., Ltd., Osaka (JP)

(72) Inventors: TAKAIKI NOMURA, Osaka (JP); KAZUKI NAKAMURA, Osaka (JP); YASUHISA INADA, Osaka (JP)

(21) Appl. No.: 18/163,277

(22) Filed: Feb. 1, 2023

Related U.S. Application Data
(63) Continuation of application No. PCT/JP2021/030304, filed on Aug. 19, 2021.

(30) Foreign Application Priority Data
Aug. 31, 2020 (JP) 2020-145420

(51) Int. Cl. G02F 1/03; G02F 1/01; G02F 1/1333; G02F 1/1335

(52) U.S. Cl. CPC G02F 1/0311; G02F 1/0115; G02F 1/133371; G02F 1/133555

(57) ABSTRACT

An optical device includes a first structure body with a first surface, a second structure body with a second surface facing the first surface, one or more optical guide regions positioned between the first surface of the first structure body and the second surface of the second structure body, the one or more optical guide regions including a liquid crystal material, and a first alignment film disposed on the first surface and aligning the liquid crystal material, the first alignment film being a rubbing alignment film, wherein the optical device further includes a second alignment film that is an optical alignment film formed by irradiation with polarized light.

### BACKGROUND

### 1. Technical Field

The present disclosure relates to an optical device and an optical detection system.

### 2. Description of the Related Art

Various devices capable of scanning a space with light have been proposed so far.

International Publication No. 2013/168266 discloses a configuration in which a light scan can be performed by using a drive device to rotate a mirror.

Japanese Unexamined Patent Application Publication (Translation of PCT Application) No. 2016-508235 discloses an optical phased array including nano-photonic antenna elements that are two-dimensionally arrayed. The antenna elements are each optically coupled to a variable optical delay line (namely, a phase shifter). In the disclosed optical phased array, a coherent light beam is guided to each antenna element through a waveguide, and a phase of the light beam is shifted by the phase shifter. With such a configuration, an amplitude distribution of a far field radiation pattern can be changed.

Japanese Unexamined Patent Application Publication No. 2013-16591 discloses a light deflection element including a waveguide that includes an optical guide layer through which light is guided and a first distribution Bragg reflecting mirror formed on each of an upper surface and a lower surface of the optical guide layer, a light inlet through which the light is introduced into the waveguide, and a light outlet formed in a surface of the waveguide to emit the light having been introduced from the light inlet and guided through the waveguide.

### SUMMARY

One non-limiting and exemplary embodiment provides an optical device with a relatively simple configuration and less light loss.

In one general aspect, the techniques disclosed here feature an optical device including a first structure body with a first surface, a second structure body with a second surface facing the first surface, one or more optical guide regions positioned between the first surface of the first structure body and the second surface of the second structure body, the one or more optical guide regions including a liquid crystal material, and a first alignment film disposed on the first surface and aligning the liquid crystal material, the first alignment film being a rubbing alignment film, wherein the optical device further includes a second alignment film that is an optical alignment film formed by irradiation with polarized light.

In one general aspect, the techniques disclosed here feature an optical device including a first structure body with a first surface, a second structure body with a second surface facing the first surface, one or more optical guide regions positioned between the first surface of the first structure body and the second surface of the second structure body, the one or more optical guide regions including a liquid crystal material, and a first alignment film disposed on the first surface and aligning the liquid crystal material, the first alignment film being a rubbing alignment film, wherein (A) the second surface is in contact with the liquid crystal material without any alignment film interposed therebetween, or (B) the optical device further includes a second alignment film that is disposed on the second surface, that is an alignment film other than the rubbing alignment film, and that aligns the liquid crystal material.

It should be noted that generic or specific embodiments of the present disclosure may be implemented in the form of a system, a device, a method, an integrated circuit, a computer program, or a recording medium such as a computer-readable recording disc, and in any selective combinations of a system, a device, a method, an integrated circuit, a computer program, and a recording medium. The computer-readable recording medium may include, for example, a nonvolatile recording medium such as a CD-ROM (Compact Disc-Read Only Memory). The device may be composed of one or more devices. When the device is composed of two or more devices, those two or more devices may be arranged in one unit or may be separately arranged in different two or more units. In this Specification and Claims, the word “device” may indicate not only a single device, but also a system composed of devices.

According to an aspect of the present disclosure, the optical device can be realized with a relatively simple configuration and less light loss.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic perspective view illustrating a configuration of an optical scanning device;

FIG. 2 is a schematic view illustrating an example of a sectional structure of one waveguide element and an example of propagating light;

FIG. 3A illustrates a cross-section of a waveguide array that emits light in a direction perpendicular to an exit surface of the waveguide array;

FIG. 3B illustrates a cross-section of a waveguide array that emits light in a direction different from the direction perpendicular to the exit surface of the waveguide array;

FIG. 4 is a schematic perspective view illustrating a waveguide array in a three-dimensional space;

FIG. 5 is a schematic view when a waveguide array and a phase shifter array are viewed from a direction normal to a light exit surface (namely, from a Z-direction);

FIG. 6A is a schematic plan view illustrating an example of an optical device according to a first embodiment of the present disclosure;

FIG. 6B illustrates a state in which constituent elements on an upper side are excluded from FIG. 6A;

FIG. 7A is a sectional view taken along line VIIA-VIIA in FIGS. 6A and 6B;

FIG. 7B is a sectional view taken along line VIIB-VIIB in FIGS. 6A and 6B;

FIG. 7C is a sectional view taken along line VIIC-VIIC in FIGS. 6A and 6B;

FIG. 8A is a schematic sectional view illustrating an example of an optical device according to a second embodiment of the present disclosure;

FIG. 8B is a schematic sectional view illustrating the example of the optical device according to the second embodiment of the present disclosure;

FIG. 8C is a schematic sectional view illustrating the example of the optical device according to the second embodiment of the present disclosure;

FIG. 9A is an explanatory view illustrating a second alignment film in the second embodiment;

FIG. 9B is an explanatory view illustrating the second alignment film in the second embodiment;

FIG. 9C is an explanatory view illustrating the second alignment film in the second embodiment;

FIG. 9D is an explanatory view illustrating the second alignment film in the second embodiment;

FIG. 9E is an explanatory view illustrating the second alignment film in the second embodiment;

FIG. 10A is a schematic view illustrating a situation in which light is emitted from the optical device according to the first embodiment;

FIG. 10B is a schematic view illustrating a situation in which light is emitted from the optical device according to the second embodiment;

FIG. 11A is a schematic plan view illustrating an example of an optical device according to a modification of the second embodiment of the present disclosure;

FIG. 11B illustrates a state in which constituent elements on an upper side are excluded from FIG. 11A;

FIG. 12A is a sectional view taken along line XIIA-XIIA in FIGS. 11A and 11B;

FIG. 12B is a sectional view taken along line XIIB-XIIB in FIGS. 11A and 11B;

FIG. 12C is a sectional view taken along line XIIC-XIIC in FIGS. 11A and 11B;

FIG. 13 illustrates an example of configuration of an optical scanning device in which individual elements, such as an optical demultiplexer, the waveguide array, the phase shifter array, and a light source, are integrated on a circuit board;

FIG. 14 is a schematic view illustrating a situation in which a two-dimensional scan is performed by emitting a light beam, such as a laser beam, to a far field from the optical scanning device; and

FIG. 15 is a block diagram illustrating an example of configuration of a LiDAR system capable of creating a distance measurement image.

### DETAILED DESCRIPTIONS

It is to be noted that any embodiments described below represent generic or specific examples. Numerical values, shapes, materials, constituent elements, layout positions of and connection forms between the constituent elements, steps, order of the steps, etc., which are described in the following embodiments, are merely illustrative, and they are not purported to limit the technique of the present disclosure. Ones of the constituent elements in the following embodiments, those ones being not stated in independent claims representing the most significant concept, are explained as optional constituent elements. Furthermore, the drawings are schematic views and are not always exactly drawn in a strict sense. In the drawings, substantially the same or similar constituent elements are denoted by the same reference sings. Duplicate description is omitted or simplified in some cases.

### Underlying Knowledge Forming Basis of the Present Disclosure

Prior to explaining the embodiments of the present disclosure, the underlying knowledge forming the basis of the present disclosure is described.

The inventor has found that an optical scanning device of related art has a difficulty in scanning a space with light without making a device configuration complicated.

For example, the technique disclosed in International Publication No. 2013/168266 needs the drive device to rotate the mirror. Therefore, the device configuration is complicated, and the device is not robust against vibrations.

In the optical phased array disclosed in Japanese Unexamined Patent Application Publication (Translation of PCT Application) No. 2016-508235, it is needed to demultiplex light, to introduce the demultiplexed lights to column waveguides and row waveguides, and to guide those lights to the antenna elements that are two-dimensionally arrayed. Therefore, routing of the waveguides for guiding the lights becomes very complicated. Moreover, a two-dimensional scan cannot be realized over a large range. In addition, to two-dimensionally change the amplitude distribution of emitted light in the far field, the phase shifter has to be connected to each of the two-dimensionally arrayed antenna elements, and a wiring line for phase control has to be attached to the phase shifter. With such a configuration, phases of lights incident on the two-dimensionally arrayed antenna elements are changed in different amounts. Hence the device configuration is very complicated.

The inventor has focused on the above-described problems in the related art and has studied techniques to solve the problems. The inventor has found that the above-described problems can be solved by using a waveguide element including a pair of mirrors facing each other and an optical guide layer sandwiched between the mirrors. One of the pair of mirrors in the waveguide element has a higher light transmittance than the other mirror and causes part of light propagating in the optical guide layer to be emitted to the outside. As described later, a direction (or an exit angle) of the emitted light can be changed by adjusting a refractive index or a thickness of the optical guide layer or a wavelength of light input to the optical guide layer. In more detail, a component of a wave vector of the emitted light along a lengthwise direction of the optical guide layer can be changed by changing the refractive index, the thickness, or the wavelength. As a result, a one-dimensional scan can be realized.

Furthermore, a two-dimensional scan can also be realized in the case of using an array of waveguide elements. In more detail, a direction in which lights emitted from the waveguide elements strengthen each other can be changed by giving an appropriate phase difference between lights supplied to the waveguide elements and by adjusting the phase difference. With the change of the phase difference, components of wave vectors of the emitted lights in a direction intersecting the lengthwise direction of the optical guide layers are changed. This enables the two-dimensional scan to be realized. Even when the two-dimensional scan is performed, it is not required to change the refractive indexes or the thicknesses of the optical guide layers or the light wavelengths in different amounts. In other words, the two-dimensional scan can be performed by giving the appropriate phase difference between the lights supplied to the optical guide layers and by synchronously changing at least ones of the refractive indexes or the thicknesses of the optical guide layers or the wavelengths in the same amount. Thus, according to an embodiment of the present disclosure, the two-dimensional scan with light can be realized with a relatively simple configuration.

In this Specification, the wording “at least one of the refractive index, the thickness, or the wavelength” indicates at least one selected from the group consisting of the refractive index of the optical guide layer, the thickness of the optical guide layer, and the wavelength of the light input to the optical guide layer. To change a light exit direction, any one of the refractive index, the thickness, or the wavelength may be controlled alone. Alternatively, arbitrary two or all of those three parameters may be controlled to change the light exit direction. In each of embodiments described below, the wavelength of the light input to the optical guide layer may be controlled instead of or in addition to control of the refractive index or the thickness.

The above-described basic principle can be applied in a similar manner to not only the case of emitting light, but also the case of receiving an optical signal. A direction in which light is receivable can be one-dimensionally changed by changing at least one of the refractive index, the thickness, or the wavelength. Furthermore, the direction in which light is receivable can be two-dimensionally changed by changing a phase difference between lights with phase shifters connected to the waveguide elements in one-to-one correspondence, those waveguide elements being arrayed in one direction.

An optical scanning device and a light receiving device according to the embodiment of the present disclosure may be used as an antenna in an optical detection system such as a LiDAR (Light Detection and Ranging) system, for example. In comparison with a radar system using a millimeter wave, the LiDAR system can detect a distance distribution of objects with higher resolution because of using an electromagnetic wave (visible light, an infrared ray, or an ultraviolet ray) of a shorter wavelength. The LiDAR system may be mounted on a mobile unit such as a car, a UAV (Unmanned Aerial Vehicle, so-called drone), or an AGV (Automated Guided Vehicle), for example, and may be used as one of collision avoidance techniques. In this Specification, the optical scanning device and the light receiving device are collectively referred to as an “optical device” in some cases. In addition, a device used in the optical scanning device or the light receiving device is also referred to as an “optical device” in some cases.

A basic configuration example and an operating principle of the optical device will be described below.

### Basic Configuration Example of Optical Scanning Device

A configuration of the optical scanning device for performing a two-dimensional scan will be described below as an example. However, more detailed description than necessary is omitted in some cases. For example, detailed description of the well-known matters is omitted in some cases. This is to avoid the following description from becoming too redundant and to promote easier understanding of those skilled in the art.

In the present disclosure, the word “light” indicates not only visible light (of wavelength longer than or equal to about 400 nm and shorter than or equal to about 700 nm), but also electromagnetic waves including an ultraviolet ray (of wavelength longer than or equal to about 10 nm and shorter than or equal to about 400 nm) and an infrared ray (of wavelength longer than or equal to about 700 nm and shorter than or equal to about 1 mm). In this Specification, the ultraviolet ray is referred to as “ultraviolet light”, and the infrared ray is referred to as “infrared light” in some cases.

In the present disclosure, the “scan” with light indicates that a direction of the light is changed. The wording “one-dimensional scan” indicates that the direction of the light is linearly changed along a direction intersecting the direction of the light. The wording “two-dimensional scan” indicates that the direction of the light is two-dimensionally changed along a plane intersecting the direction of the light.

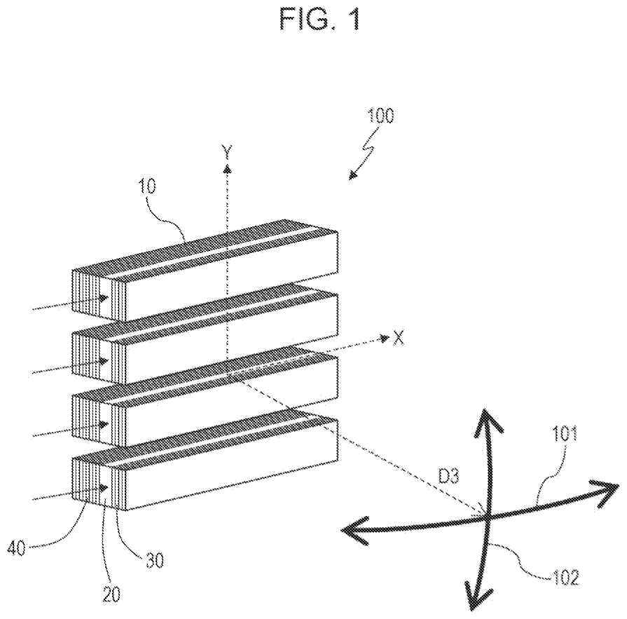

FIG. 1 is a schematic perspective view illustrating a configuration of an optical scanning device 100. The optical scanning device 100 includes a waveguide array including waveguide elements (optical waveguides) 10. Each of the waveguide elements 10 has a shape extending in a first direction (X-direction in FIG. 1). The waveguide elements 10 are regularly arrayed in a second direction (Y-direction in FIG. 1) intersecting the first direction. The waveguide elements 10 emit lights in a third direction D3 intersecting an imaginary plane parallel to the first and second directions while allowing the lights to propagate in the first direction. Although the first direction (X-direction) and the second direction (Y-direction) are orthogonal to each other in this embodiment, those directions are not always required to be orthogonal to each other. Although the waveguide elements 10 are arrayed at equal intervals in the Y-direction in this embodiment, they are not always required to be arrayed at equal intervals.

An orientation of a structure body illustrated in the drawings attached to this application is set in consideration of easy understanding of the description and is not intended to restrict the orientation when the embodiment of the present disclosure is actually put into practice. A shape and a size of the whole or part of the structure body, illustrated in the drawings, are also not intended to restrict an actual shape and size in practical use.

Each of the waveguide elements 10 includes a pair of a first mirror 30 and a second mirror 40 facing each other (which are each simply referred to as a “mirror” in some cases hereinafter) and an optical guide layer 20 positioned between the mirror 30 and the mirror 40. Each of the mirror 30 and the mirror 40 has, at an interface with the optical guide layer 20, a reflecting surface intersecting the third direction D3. The mirror 30, the mirror 40, and the optical guide layer 20 have shapes extending in the first direction (X-direction).

As described later, the first mirrors 30 of the waveguide elements 10 may be portions of an integrally formed mirror. The second mirrors 40 of the waveguide elements 10 may be portions of an integrally formed mirror. Furthermore, the optical guide layers 20 of the waveguide elements 10 may be portions of an integrally formed optical guide layer. Waveguides can be formed on condition of satisfying at least one of (1) each first mirror 30 is constituted separately from another first mirror 30, (2) each second mirror 40 is constituted separately from another second mirror 40, or (3) each optical guide layer 20 is constituted separately from another optical guide layer 20. The wording “constituted separately” indicates not only the case in which two members are physically arranged with a space kept between the two members, but also the case in which two members are separated while a material with a different refractive index is interposed between the two members.

The reflecting surface of the first mirror 30 and the reflecting surface of the second mirror 40 face each other substantially parallel. Of the two mirrors 30 and 40, at least the first mirror 30 has a characteristic of allowing part of light propagating in the optical guide layer 20 to pass through the first mirror 30. In other words, the first mirror 30 has a higher light transmittance for the propagating light than the second mirror 40. Therefore, part of the light propagating in the optical guide layer 20 is emitted to the outside from the first mirror 30. The above-described mirrors 30 and 40 may be each, for example, a multilayer film mirror that is formed of a multilayer film (also referred to as a “multilayer reflecting film” in some cases) made of a dielectric.

The two-dimensional scan with light can be realized by controlling a phase of the light input to each of the waveguide elements 10, and by synchronously changing refractive indexes or thicknesses of the optical guide layers 20 in the waveguide elements 10 or wavelengths of lights input to the optical guide layers 20 at the same time.

To realize the above-described two-dimensional scan, the inventor has analyzed the operating principle of the waveguide element 10. On the basis of the analysis result, the inventor has succeeded in realizing the two-dimensional scan with light by synchronously driving the waveguide elements 10.

As illustrated in FIG. 1, when lights are input to the waveguide elements 10, the lights are emitted from exit surfaces of the waveguide elements 10. The exit surfaces are each positioned on an opposite side to the reflecting surface of the first mirror 30. The direction D3 of each emitted light depends on the refractive index and the thickness of the optical guide layer and the light wavelength. In this embodiment, at least ones of the refractive indexes or the thicknesses of the individual optical guide layers or the wavelengths are controlled synchronously such that the lights are emitted from the individual waveguide elements 10 substantially in the same direction. As a result, X-directional components of the wave vectors of the lights emitted from the waveguide elements 10 can be changed. In other words, the direction D3 of the emitted light can be changed along a direction 101 illustrated in FIG. 1.

Furthermore, since the lights emitted from the waveguide elements 10 are oriented in the same direction, the emitted lights interfere with each other. Therefore, a direction in which the lights strengthen each other with interference can be changed by controlling phases of the lights emitted from the waveguide elements 10. For example, when the waveguide elements 10 of the same size are arrayed at equal intervals in the Y-direction, lights with phases different in units of a certain amount are input to the waveguide elements 10. By changing a difference between the phases, Y-directional components of the wave vectors of the emitted lights can be changed. In other words, by changing the phase difference between the lights introduced to the waveguide elements 10, the direction D3 in which the emitted lights strengthen each other with interference can be changed along a direction 102 illustrated in FIG. 1. As a result, the two-dimensional scan with light can be realized.

The operating principle of the optical scanning device 100 will be described below.

### Operating Principle of Waveguide Element

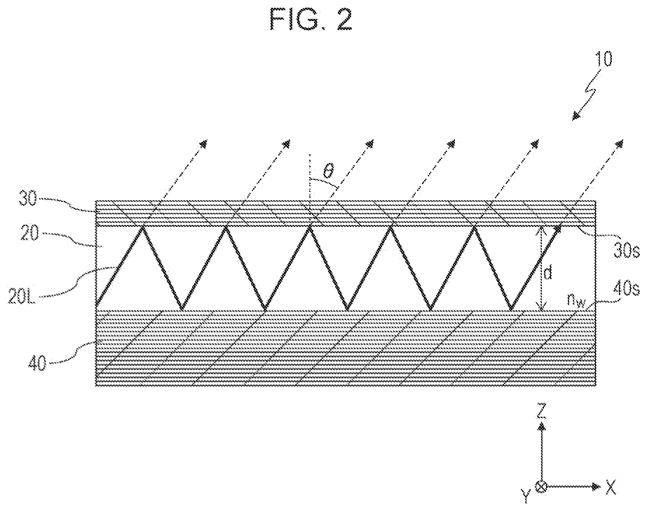

FIG. 2 is a schematic view illustrating an example of a sectional structure of one waveguide element 10 and an example of propagating light. In FIG. 2, a direction perpendicular to the X-direction and the Y-direction illustrated in FIG. 1 is assumed to be a Z-direction, and a cross-section of the waveguide element 10 parallel to an XZ plane is schematically illustrated. In the waveguide element 10, the first mirror 30 and the second mirror 40 are disposed with the optical guide layer 20 sandwiched therebetween. The first mirror 30 has a first reflecting surface 30s. The second mirror 40 has a second reflecting surface 40s positioned to face the first reflecting surface 30s. Light 20L introduced from one end of the optical guide layer 20 in the X-direction propagates in the optical guide layer 20 while repeating reflections at the first reflecting surface 30s of the first mirror 30 disposed at an upper surface (surface on an upper side in FIG. 2) of the optical guide layer 20 and at the second reflecting surface 40s of the second mirror 40 disposed at a lower surface (surface on a lower side in FIG. 2) of the optical guide layer 20. The light transmittance of the first mirror 30 is higher than that of the second mirror 40. Accordingly, part of the light can be output mainly through the first mirror 30.

In a waveguide such as a general optical fiber, light propagates along the waveguide while repeating total reflection. By contrast, in the waveguide element 10 in this embodiment, the light propagates while repeating reflections at the mirrors 30 and 40 disposed respectively on the upper and lower sides of the optical guide layer 20. Accordingly, there are no restrictions on a light propagation angle. Here, the term “light propagation angle” indicates an angle incident on an interface between the mirror 30 or the mirror 40 and the optical guide layer 20. Even light incident on the mirror 30 or the mirror 40 at an angle closer to a right angle can propagate in the optical guide layer 20. In other words, light incident on the interface at a smaller angle than a critical angle for the total reflection can also propagate. Therefore, the group velocity of the light in the light propagation direction is greatly reduced in comparison with the light velocity in a free space. As a result, the waveguide element 10 has such a property that light propagation conditions are greatly changed with respect to change in the light wavelength, the thickness of the optical guide layer 20, and the refractive index of the optical guide layer 20. The waveguide with such a property is referred to as a “reflection waveguide” or a “slow light waveguide”.

An exit angle θ of light emitted from the waveguide element 10 into air is expressed by the following formula (1).

$$sin θ = \sqrt{{n}_{w}^{2} - {( \frac{m λ}{2 d} )}^{2}} \qquad ( 1 )$$

As seen from the formula (1), the light exit direction can be changed by changing any of a light wavelength λ in air, a refractive index n_{w} of the optical guide layer 20, and a thickness d of the optical guide layer 20.

In the case of n_{w}=2, d=387 nm, =1550 nm, and m=1, for example, the exit angle is 0°. When the refractive index is changed to n_{w}=2.2 from the above condition, the exit angle is changed to about 66°. On the other hand, when the thickness is changed to d=420 nm without changing the refractive index, the exit angle is changed to about 51°. When the wavelength is changed to λ=1500 nm without changing the refractive index and the thickness, the exit angle is changed to about 30°. Thus, the light exit direction can be greatly changed by changing any of the light wavelength k, the refractive index n_{w} of the optical guide layer 20, and the thickness d of the optical guide layer 20.

From the above point of view, in the optical scanning device 100, the light exit direction is controlled by controlling at least one of the wavelength λ of the light input to the optical guide layer 20, the refractive index n_{w} of the optical guide layer 20, or the thickness d of the optical guide layer 20. The wavelength λ of the input light may be kept constant without changing it during the operation. In that case, the light scan can be realized with a simpler configuration. The wavelength λ is not limited to a particular value. For example, the wavelength λ may be within a wavelength range from 400 nm to 1100 nm (namely, from visible light to near infrared light) where high detection sensitivity is obtained with a general photodetector or image sensor that detects light by absorbing the light with silicon (Si). In another example, the wavelength λ may be within a near-infrared wavelength range from 1260 nm to 1625 nm where transmission loss in an optical fiber or a Si waveguide is relatively small. The above-mentioned wavelength ranges are merely examples. The wavelength range of the light used is not limited to the wavelength range of visible light or infrared light and may be a wavelength range of ultraviolet light.

To change the direction of the emitted light, the optical scanning device 100 may include a first adjuster that changes at least one of the refractive index or the thickness of the optical guide layer 20 in each waveguide element 10 or the wavelength.

As described above, the light exit direction can be greatly changed with the waveguide element 10 by changing at least one of the refractive index n_{w} or the thickness d of the optical guide layer 20 or the wavelength λ. Accordingly, the exit angle of the light emitted through the mirror 30 can be changed in the direction along the waveguide element 10. Hence the one-dimensional scan can be realized by using at least one waveguide element 10.

To adjust the refractive index of at least part of the optical guide layer 20, the optical guide layer 20 may contain a liquid crystal material or an electro-optic material. The optical guide layer 20 may be sandwiched between a pair of electrodes. The refractive index of the optical guide layer 20 can be changed by applying a voltage between the pair of electrodes.

To adjust the thickness of the optical guide layer 20, for example, at least one actuator may be connected to at least one of the first mirror 30 or the second mirror 40. The thickness of the optical guide layer 20 can be changed by changing a distance between the first mirror 30 and the second mirror 40 with the at least one actuator. The thickness of the optical guide layer 20 can be easily changed when the optical guide layer 20 is made of a liquid.

### Operating Principle for Two-Dimensional Scan

In the waveguide array in which the waveguide elements 10 are arrayed in one direction, the light exit direction is changed with interference of the lights emitted from the waveguide elements 10. The light exit direction can be changed by adjusting phases of lights supplied to the waveguide elements 10. The principle of such operation will be described below.

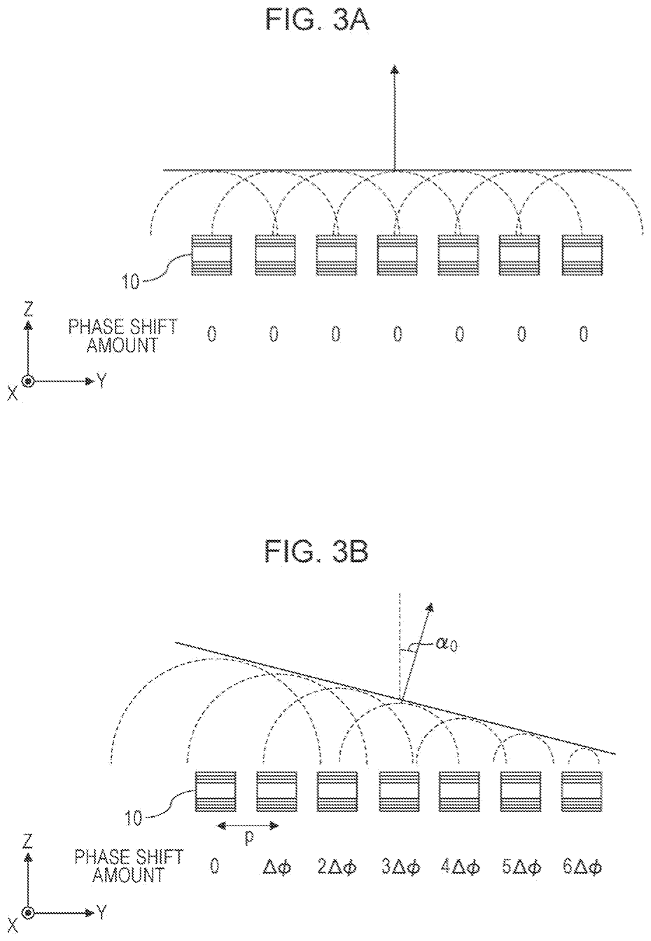

FIG. 3A illustrates a cross-section of a waveguide array that emits light in a direction perpendicular to an exit surface of the waveguide array. FIG. 3A further illustrates a phase shift amount of the light propagating in each waveguide element 10. Here, the phase shift amount is a value on the basis of a phase of the light propagating in the waveguide element 10 at a left end. The waveguide array in this embodiment includes the waveguide elements 10 arrayed at equal intervals. In FIG. 3A, a circular arc denoted by a dashed line represents a wave front of the light emitted from each waveguide element 10. A linear line represents a wave front formed by the light interference. An arrow represents a direction of light emitted from the waveguide array (namely, a direction of a wave vector thereof). In the example of FIG. 3A, the phases of the lights propagating in the optical guide layers 20 in the individual waveguide elements 10 are the same. In this case, the light is emitted in a direction (Z-direction) perpendicular to both the direction (Y-direction) in which the waveguide elements 10 are arrayed and the direction (X-direction) in which the optical guide layers 20 extend.

FIG. 3B illustrates a cross-section of a waveguide array that emits light in a direction different from the direction perpendicular to an exit surface of the waveguide array. In the example of FIG. 3B, the phases of the lights propagating in the optical guide layers 20 in the individual waveguide elements 10 are different in units of a certain amount (Δφ) in the array direction. In this case, the light is emitted in a direction different from the Z-direction. A component of a wave vector of each light in the Y-direction can be changed by changing Δφ. Assuming that a center-to-center distance between two adjacent waveguide elements 10 is denoted by p, a light exit angle α₀ is expressed by the following formula (2).

$$sin {α}_{0} = \frac{Δ ϕ λ}{2 π p} \qquad ( 2 )$$

In the example illustrated in FIG. 2, the light exit direction is parallel to the XZ plane. Thus, α₀=0°. In the examples illustrated in FIGS. 3A and 3B, the direction of the light emitted from the optical scanning device 100 is parallel to a YZ plane. Thus, θ=0°. In general, however, the direction of the light emitted from the optical scanning device 100 is not parallel to the ZX plane and the YZ plane. Thus, θ≠0° and α₀≠0°.

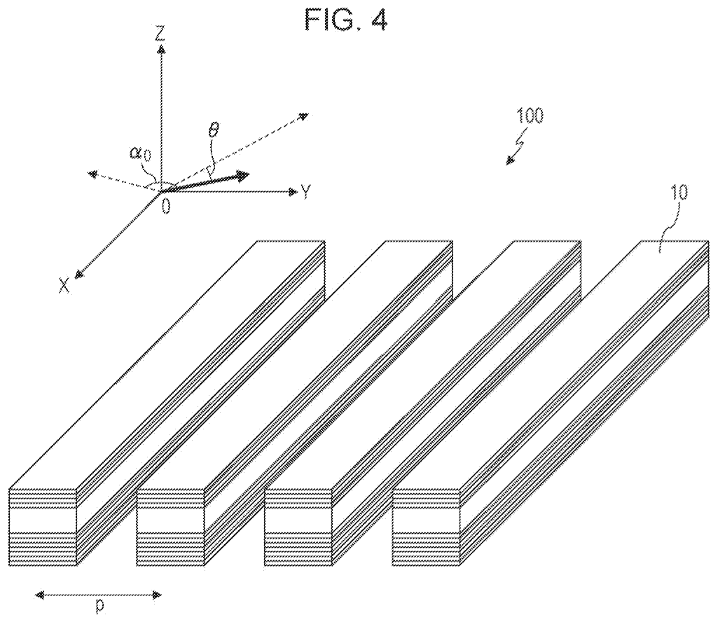

FIG. 4 is a schematic perspective view illustrating a waveguide array in a three-dimensional space. A thick arrow illustrated in FIG. 4 represents a direction of the light emitted from the optical scanning device 100. θ represents an angle formed between the light exit direction and the YZ plane. θ satisfies the formula (1). α₀ represents an angle formed between the light exit direction and the XZ plane. α₀ satisfies the formula (2).

### Phase Control of Lights Introduced to Waveguide Array

To control a phase of the light emitted from each waveguide element 10, a phase shifter for changing a light phase may be disposed, for example, in a stage prior to introducing the light to the waveguide element 10. The optical scanning device 100 includes phase shifters connected to the waveguide elements 10 in one-to-one correspondence, and second adjusters for adjusting phases of lights propagating through the phase shifters. Each of the phase shifters includes a waveguide connected directly or through another waveguide to the optical guide layer 20 in corresponding one of the waveguide elements 10. The second adjusters change phase differences between the lights propagating from the phase shifters to the waveguide elements 10, thereby changing the direction in which the lights are emitted from the waveguide elements 10 (namely, the third direction D3). In the following description, similar to the waveguide array, the arrayed phase shifters are also referred to as a “phase shifter array” in some cases.

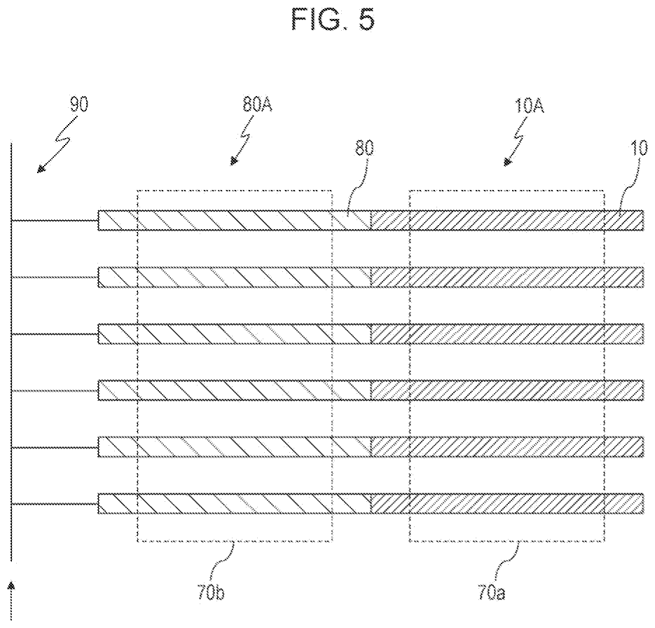

FIG. 5 is a schematic view when a waveguide array 10A and a phase shifter array 80A are viewed from a direction normal to the light exit surface (namely, from the Z-direction). In the example illustrated in FIG. 5, all phase shifters 80 have the same propagation characteristic, and all the waveguide elements 10 have the same propagation characteristic. The lengths of the phase shifters 80 may be the same or different, and the lengths of the waveguide elements 10 may be the same or different. When the lengths of the phase shifters 80 are the same, phase shift amounts given by the phase shifters 80 can be adjusted with drive voltages, for example. Alternatively, with a structure in which the lengths of the phase shifters 80 are changed in equal steps, phase shifts changing in equal steps can be given by applying the same drive voltage. The optical scanning device 100 further includes an optical demultiplexer 90 that demultiplexes light and supplies demultiplexed lights to the phase shifters 80, a first drive circuit 70a that drives each of the waveguide elements 10, and a second drive circuit 70b that drives each of the phase shifters 80. A linear arrow in FIG. 5 represents an input of the light. The two-dimensional scan can be realized by independently controlling the first drive circuit 70a and the second drive circuit 70b that are disposed separately. In the illustrated example, the first drive circuit 70a functions as one element of the first adjuster, and the second drive circuit 70b functions as one element of the second adjuster.

The first drive circuit 70a changes an angle of the light emitted from the optical guide layer 20 by changing at least one of the refractive index or the thickness of the optical guide layer 20 in each waveguide element 10. The second drive circuit 70b changes a phase of the light propagating through a waveguide in each phase shifter 80 by changing a refractive index of the waveguide. The optical demultiplexer 90 may be constituted by a waveguide through which light propagates with total reflection, or by a reflection waveguide similar to the waveguide element 10.

In another example, after controlling the phases of the lights demultiplexed by the optical demultiplexer 90, the lights may be introduced to the phase shifters 80. For such phase control, for example, a passive phase control structure for adjusting the lengths of waveguides up to the phase shifters 80 can be used. Alternatively, other phase shifters may be used which have similar functions to those of the phase shifters 80 and which are able to perform control with electric signals. The above-mentioned methods may be optionally used to adjust the phases of the lights before being introduced to the phase shifters 80 such that the lights in the same phase are supplied to all the phase shifters 80. With that adjustment, control of the phase shifters 80 by the second drive circuit 70b can be simplified.

An optical device with a similar configuration to that of the above-described optical scanning device 100 can also be utilized as a light receiving device. Details of the operating principle and method for such an optical device are disclosed in U.S. Unexamined Patent Application Publication No. 2018/0224709. The entire contents disclosed in the above-mentioned document are incorporated in this Specification by reference.

### Liquid Crystal Alignment Film

When the optical guide layer 20 contains a liquid crystal material, an alignment film for aligning the major axes of liquid crystal molecules in the liquid crystal material in a particular direction may be disposed on the reflecting surface 30s of the mirror 30 and the reflecting surface 40s of the mirror 40. The alignment film may be made of a material, such as polyimide, that can apply a relatively high alignment restriction force. An alignment direction of the alignment film may be defined by rubbing, for example. An alignment film formed with a rubbing process performed on polyimide or the like material is thick, and its thickness is nonuniform. When light enters such an alignment film, absorption and scattering of the light occur. When the light propagates in the optical guide layer 20 along the X-direction with multiple reflections as illustrated in FIG. 2, the light is absorbed and scattered many times by the alignment films on the upper and lower sides. As a result, non-negligible light loss may be caused in the optical guide layer 20. According to the study made by the inventor, the light loss is about 50%.

From the viewpoint of solving the above-mentioned problem, the inventor has succeeded in coming up with the concepts of the embodiments (described later) of the present disclosure. An optical device according to one embodiment of the present disclosure may be fabricated by combining a first structure body including the above-mentioned first mirror and so on and a second structure body including the above-mentioned second mirror and so on with each other. A region corresponding to the above-mentioned optical guide layer is formed between a surface of the first structure body (hereinafter also referred to as a “first surface”) and a surface of the second structure body (hereinafter also referred to as a “second surface”). That region is referred to as an “optical guide region”. The optical guide region may be formed of a liquid crystal material, for example. The optical guide region may contain a material other than the liquid crystal material. In one embodiment, a first alignment film in which the alignment direction for the liquid crystal material is defined by the rubbing is disposed on the first surface, while the alignment film is not disposed on the second surface. Accordingly, the loss of the propagating light can be suppressed in comparison with the configuration in which the alignment film causing the non-negligible light loss is disposed on each of the first surface and the second surface. In another embodiment, the first alignment film in which the alignment direction is defined by the rubbing is disposed on the first surface, while a second alignment film in which the alignment direction is defined without resorting to the rubbing is disposed on the second surface. The second alignment film may be an alignment film that is coupled to the second surface with, for example, siloxane coupling of silicon (Si) and oxygen (O) interposed therebetween (see, for example, Japanese Unexamined Patent Application Publication No. 2001-100214). The alignment direction of the second alignment film may be defined by, for example, irradiation with polarized light. Light loss caused by the second alignment film is as small as negligible. Accordingly, the loss of the propagating light can be suppressed in comparison with the configuration in which the rubbing alignment film is disposed on each of the first surface and the second surface. Since the second alignment film is used in addition to the first alignment film, the alignment direction of the liquid crystal material can be made more uniform. The optical device and the optical detection system according to the embodiments of the present disclosure will be described below in brief.

An optical device according to one general aspect includes a first structure body with a first surface, a second structure body with a second surface facing the first surface, one or more optical guide regions positioned between the first surface of the first structure body and the second surface of the second structure body, the one or more optical guide regions including a liquid crystal material, and a first alignment film disposed on the first surface and aligning the liquid crystal material, the first alignment film being a rubbing alignment film, wherein the optical device further includes a second alignment film that is an optical alignment film formed by irradiation with polarized light.

An optical device according to a first aspect includes a first structure body with a first surface, a second structure body with a second surface facing the first surface, one or more optical guide regions positioned between the first surface of the first structure body and the second surface of the second structure body, the one or more optical guide regions including a liquid crystal material, and a first alignment film disposed on the first surface and aligning the liquid crystal material, the first alignment film being a rubbing alignment film. (A) The second surface is in contact with the liquid crystal material without any alignment film interposed therebetween. Alternatively, (B) the optical device further includes a second alignment film that is disposed on the second surface, that is an alignment film other than the rubbing alignment film, and that aligns the liquid crystal material.

According to the optical device described above, the loss of light propagating in the optical guide region can be suppressed.

An optical device according to a second aspect features that, in the optical device according to the first aspect, the second alignment film is an optical alignment film formed by irradiation with polarized light.

According to the optical device described above, the alignment direction of the alignment film can be defined without resorting to the rubbing.

An optical device according to a third aspect features that, in the optical device according to the first or second aspect, the second alignment film is a film containing a material that is bonded to the second surface through a siloxane bond interposed therebetween.

According to the optical device described above, adhesivity and coverage of the second alignment film can be increased with the siloxane bond.

An optical device according to a fourth aspect features that, in the optical device according to the third aspect, the film is a monomolecular film.

According to the optical device described above, the light loss in the monomolecular alignment film is substantially negligible.

An optical device according to a fifth aspect features that, in the optical device according to any one of the first to fourth aspects, the second surface has one or more recesses with a depth of greater than or equal to 1 μm and smaller than or equal to 10 μm. The liquid crystal material fills the one or more recesses.

According to the optical device described above, the liquid crystal material can be aligned by the first alignment film even when the recesses have the depth of greater than or equal to 1 μm and smaller than or equal to 10 μm.

An optical device according to a sixth aspect features that, in the optical device according to the fifth aspect, the one or more recesses are multiple recesses, and the one or more optical guide regions are multiple optical guide regions. The multiple optical guide regions include the multiple recesses in one-to-one correspondence.

According to the optical device described above, light can be caused to propagate in each of the multiple optical guide regions.

An optical device according to a seventh aspect features that, in the optical device according to any one of the first to sixth aspects, the first surface is a flat surface or an uneven surface with a difference in height of less than 1 μm. The liquid crystal material covers the flat surface or the uneven surface.

According to the optical device described above, the alignment film of which alignment direction is defined by the rubbing can be disposed on the first surface with less unevenness.

An optical device according to an eighth aspect features that, in the optical device according to any one of the first to seventh aspects, the first structure body includes a first mirror having the first surface, and the second structure body includes a second mirror having the second surface.

According to the optical device described above, light can be caused to propagate in the optical guide region with reflections by the first mirror and the second mirror regardless of a critical angle for total reflection.

An optical device according to a ninth aspect features that, in the optical device according to the eighth aspect, the first mirror and the second mirror are each formed of a dielectric multilayer film.

According to the optical device described above, light can be reflected by the mirror that contains no metal and that is formed of the dielectric multilayer film, without substantially causing the loss of the light.

An optical device according to a tenth aspect features that, in the optical device according to the ninth aspect, the first mirror has a higher light transmittance than the second mirror.

According to the optical device described above, the light propagating in the optical guide region can be emitted to the outside through the first mirror.

An optical device according to an eleventh aspect features that, in the optical device according to the tenth aspect, the first structure body includes a first electrode, the second structure body includes a second electrode facing the first electrode. The one or more optical guide regions are positioned between the first electrode and the second electrode. A direction of light emitted from the one or more optical guide regions through the first structure body or an incident direction of light taken into the one or more optical guide regions through the first structure body is changed by changing a voltage applied between the first electrode and the second electrode.

According to the optical device described above, by applying the voltage between the first electrode and the second electrode, it is possible to emit light to an external object positioned in a particular location or to receive light reflected from the object.

An optical device according to a twelfth aspect features that, in the optical device according to the first aspect, the optical device further includes phase shifters connected to the one or more optical guide regions directly or through other waveguides.

According to the optical device described above, a direction of light emitted from the optical device or a direction of light incident on the optical device can be changed by the phase shifters regardless of whether the optical device includes one or two or more optical guide regions extending in one direction or one planar optical guide region.

An optical device according to a thirteenth aspect features that, in the optical device according to the first aspect, the one or more optical guide regions are multiple optical guide regions. The optical device further includes multiple phase shifters connected to the multiple optical guide regions directly or through other waveguides in one-to-one correspondence.

According to the optical device described above, the direction of the light emitted from the optical device or the direction of the light incident on the optical device can be changed by the multiple phase shifters that are connected to the multiple optical guide regions in one-to-one correspondence.

An optical detection system according to a fourteenth aspect includes the optical device according to any one of the first to thirteenth aspects, an optical detector that detects light emitted from the optical device and reflected from an object, and a signal processing circuit that creates distance distribution data based on outputs of the optical detector.

According to the optical detection system described above, a distance image can be created.

In the present disclosure, all or some of circuits, units, devices, members, or portions, or all or some of functional blocks in a block diagram may be implemented with one or more electronic circuits including, for example, a semiconductor device, a semiconductor integrated circuit (IC), or an LSI (large scale integration). The LSI or the IC may be integrated in one chip or constituted by combining chips with each other. For example, functional blocks except for a storage element may be integrated in one chip. Although the term “LSI” or “IC” is used here, circuits are called in different names depending on a degree of integration, and a circuit called a system LSI, a VLSI (very large scale integration), or an VLSI (ultra large scale integration) may also be used. A Field Programmable Gate Array (FPGA) that is programmed after manufacturing of an LSI, or a reconfigurable logic device enabling connection relationships inside an LSI to be reconfigured or enabling individual circuit sections inside an LSI to be set up can be further used for the same purpose.

Functions or operations of all or some of the circuits, the units, the devices, the members, or the portions can be executed with software processing. In that case, software is recorded on one or more non-temporary recording media such as a ROM, an optical disk, and a hard disk drive. When software is executed by a processor, functions specified in the software are executed by the processor and peripheral devices. A system or a device may include one or more non-temporary recording media on which software is recorded, a processor, and other required hardware devices such as an interface.

### First Embodiment

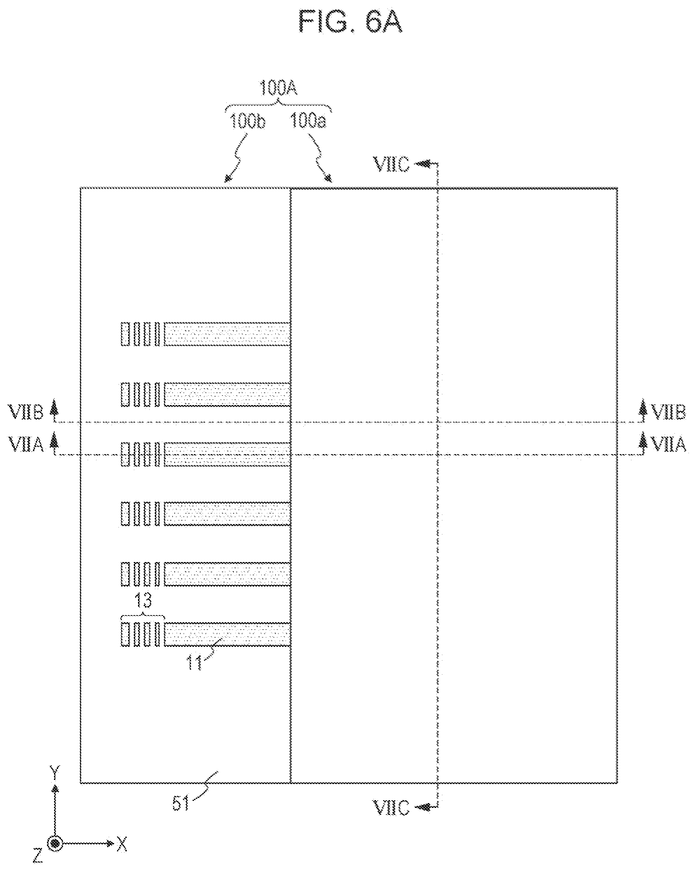

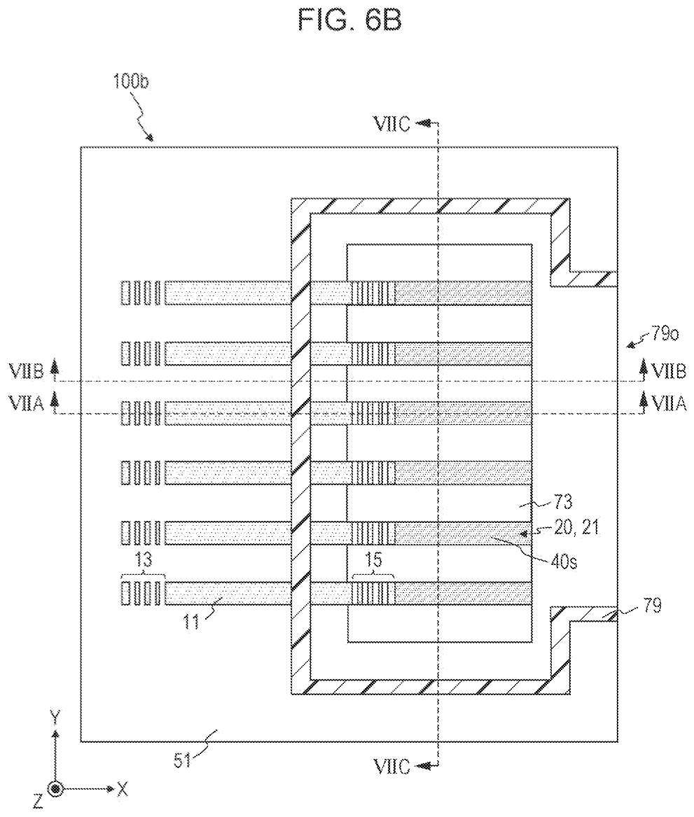

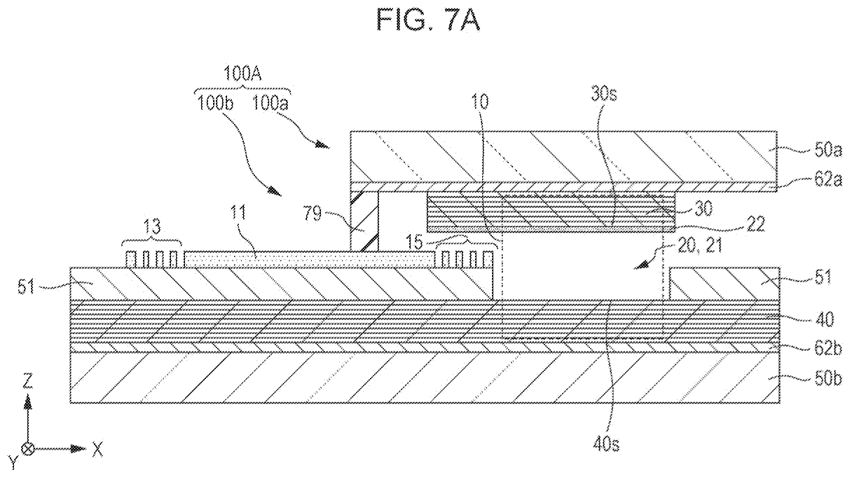

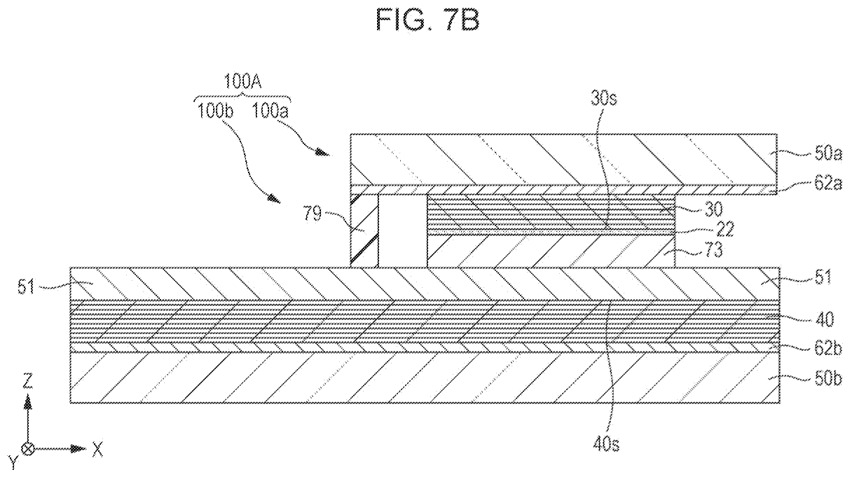

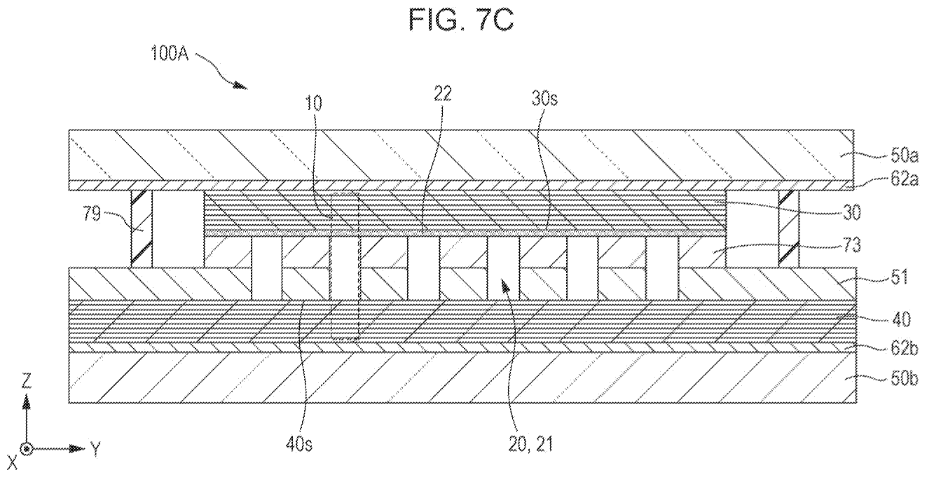

An optical device according to a first embodiment of the present disclosure will be described below with reference to FIGS. 6A to 7C. FIG. 6A is a schematic plan view illustrating a configuration of the optical device 100A according to the first embodiment of the present disclosure. FIG. 6B illustrates a state in which constituent elements on an upper side are excluded from FIG. 6A. FIGS. 7A, 7B, and 7C are sectional views taken along line VIIA-VIIA, line and line VIIC-VIIC in FIGS. 6A and 6B, respectively.

As illustrated in FIGS. 7A to 7C, the optical device 100A includes an upper structure body 100a, a lower structure body 100b, optical guide regions 20, and an alignment film 22. The optical device 100A may be fabricated by a process of, for example, affixing the upper structure body 100a and the lower structure body 100b to each other, and injecting a liquid crystal material into a space sandwiched between both the structure bodies. Part of the space into which the liquid crystal material has been injected serves as the optical guide region 20. In this Specification, a side where the upper structure body 100a is positioned is referred to as an “upper side”, and a side where the lower structure body 100b is positioned is referred to as a “lower side”. The wordings “upper portion”, “lower portion”, “upper side”, and “lower side” are not purported to restrict an orientation of the optical device 100A in use, and the optical device 100A can be disposed in an any desired orientation.

In this Specification, the upper structure body 100a is also referred to as a “first structure body 100a”, and the lower structure body 100b is also referred to as a “second structure body 100b”. A portion of a surface of the upper structure body 100a, the portion facing the lower structure body 100b, is referred to as a “first surface”. A portion of a surface of the lower structure body 100b, the portion facing the upper structure body 100a, is referred to as a “second surface”. The first surface and the second surface face each other. In the following description, the first surface of the first structure body 100a is also referred to as a “lower surface”, and the second surface of the second structure body 100b is also referred to as an “upper surface”.

The upper structure body 100a in this embodiment includes a substrate 50a, an electrode 62a, and a mirror 30. The electrode 62a, the mirror 30, and the alignment film 22 are disposed on the substrate 50a in the order mentioned.

The lower structure body 100b in this embodiment includes a substrate 50b, an electrode 62b, a mirror 40, a dielectric layer 51, partition walls 73, a sealing member 79, and optical waveguides 11. The electrode 62b is disposed on the substrate 50b. The mirror 40 is disposed on the electrode 62b. The reflecting surface 40s of the mirror 40 faces the reflecting surface 30s of the mirror 30. The dielectric layer 51 is disposed on the mirror 40. The partition walls 73, the sealing member 79, and the optical waveguides 11 are disposed on the dielectric layer 51.

The optical guide regions 20 in this embodiment are positioned between the reflecting surface 30s of the mirror 30 and the reflecting surface 40s of the mirror 40. In the example illustrated in FIG. 7C, six optical guide regions 20 arrayed along the Y-direction are each formed between adjacent two of the partition walls 73. The number of the optical guide regions 20 is not limited to six and may be any desired number of greater than or equal to 1. The optical guide region 20, a portion of the mirror 30 overlapping the optical guide region 20 when viewed from the Z-direction, and a portion of the mirror 40 overlapping the optical guide region 20 when viewed from the Z-direction form an optical waveguide. The optical waveguide functions as the above-mentioned slow light waveguide.

The alignment film 22 in this embodiment is formed on the reflecting surface 30s of the mirror 30 in the upper structure body 100a before the upper structure body 100a and the lower structure body 100b are affixed to each other.

The configuration of the optical device 100A according to this embodiment will be described in detail below.

Of the substrates 50a and 50b, the substrate on a light exit side has optical transparency. Both the substrates 50a and 50b may have optical transparency. Similarly, of the electrodes 62a and 62b, the electrode on the light exit side has optical transparency. Both the electrodes 62a and 62b may have optical transparency. At least one of the electrode 62a or 62b may be formed as, for example, a transparent electrode. In the example illustrated in FIGS. 6A to 7C, light is emitted from each optical waveguide 10 through the electrode 62a and the substrate 50a in the upper structure body 100a.

The partition walls 73 are disposed on the dielectric layer 51. The partition walls 73 are arrayed in the Y-direction. Each of the partition walls 73 has a structure extending along the X-direction. A portion of the dielectric layer 51, the portion being positioned between adjacent two of the partition walls 73 when viewed from the Z-direction, is partly removed. As a result, multiple portions of the reflecting surface 40s of the mirror 40 are exposed. The exposed portions are arrayed in the Y-direction. Each of the exposed portions has a shape extending along the X-direction. As illustrated in FIG. 7C, a portion of the dielectric layer 51, the portion having been not removed, and the partition wall 73 positioned right above the not-removed portion of the dielectric layer 51 form a protrusion extending in the X-direction. Accordingly, multiple protrusions arrayed in the Y-direction are formed on the mirror 40. Multiple recesses are formed between adjacent twos of the protrusions. Each of the recesses also has a structure extending along the X-direction. A depth of each recess, namely a height of the protrusions on both sides of each recess, may be, for example, greater than or equal to 1 μm and smaller than or equal to 10 μm. Here, the depth of the recess and the height of the protrusion indicate sizes measured along the Z-direction denoted in the drawing. In this embodiment, the recesses are formed by the dielectric layer 51 and the partition walls 73, and those recesses define the optical guide regions 20. When the number of the recesses is one, one optical guide region 20 is formed in the recess.

The optical guide regions 20 are defined in an area where the recesses are positioned when viewed from the Z-direction. The optical guide regions 20 are each surrounded by the reflecting surface 30s of the mirror 30, the reflecting surface 40s of the mirror 40, and the two adjacent projections. The optical guide region 20 includes a dielectric member 21. In this embodiment, the dielectric member 21 is made of a liquid crystal material.

The optical guide region 20 has a higher refractive index than the partition wall 73 and the dielectric layer 51. The light propagating in the optical guide region 20 does not leak to the protrusions positioned on both sides of the optical guide region 20. This is because the light propagating in the optical guide region 20 causes total reflection at the interface between the optical guide region 20 and each of the protrusions. A region where the protrusion is present can be said as being a “non-guide region”. The optical guide regions 20 and the non-guide regions are alternately arrayed in the Y-direction between the mirror 30 and the mirror 40. Such a configuration corresponds to the optical waveguides 10 arrayed in the Y-direction. The mirror 30 is positioned between an area where the optical guide regions 20 and the non-guide regions are alternately arrayed in the Y-direction and the substrate 50a. The mirror 40 is positioned between the area where the optical guide regions 20 and the non-guide regions are alternately arrayed in the Y-direction and the substrate 50b.

The electrodes 62a and 62b face each other and indirectly sandwich the dielectric member 21. The wording “indirectly sandwich” indicates that both the electrodes sandwich the dielectric member 21 with one or more other members interposed therebetween. In this embodiment, the mirror 30, the alignment film 22, and the mirror 40 are arranged between the electrodes 62a and 62b. A positional relationship between the electrode 62a and the mirror 30 may be reversed to the illustrated one. In such a case, the alignment film 22 may be formed on a surface of the electrode 62a. Similarly, a positional relationship between the electrode 62b and the mirror 40 may also be reversed to the illustrated one. By adjusting a voltage applied between the electrodes 62a and 62b, the refractive index of the dielectric member 21 can be adjusted. An exit angle of light emitted from the optical waveguide 10 to the outside is changed by changing the applied voltage.

The sealing member 79 fixedly holds a distance between the upper structure body 100a and the lower structure body 100b. As illustrated in FIG. 6B, the sealing member 79 surrounds the optical waveguides 10 and the partition walls 73 when viewed from the Z-direction. The sealing member 79 includes a portion extending along the Y-direction and portions extending along the X-direction from both ends of the former portion. The sealing member 79 is disposed on the dielectric layer 51 and is arranged such that the portion extending along the Y-direction straddles the optical waveguides 11. An upper surface of the sealing member 79 is parallel to an XY plane. A portion of the sealing member 79 in the Z-direction, the portion being positioned right above the dielectric layer 51, has a size equal to or greater than a total of respective thicknesses of the partition wall 73, the mirror 30, and the alignment film 22 (namely, a total size of those three components in the Z-direction). The sealing member 79 may be made of, for example, ultraviolet curable resin or thermosetting resin. A material of the sealing member 79 is not always required to be the ultraviolet curable resin or the thermosetting resin insofar as the material can maintain the distance between the substrate 50a and the substrate 50b for a long period. The liquid crystal material forming the dielectric member 21 may be poured into a space surrounded by the sealing member 79 with, for example, vacuum injection. With the liquid crystal material being injected into the above-mentioned space, vacuum leak can be prevented at the time of injecting the liquid crystal material.

The optical waveguides 11 are connected to the optical guide regions 20 in one-to-one correspondence. Light is supplied from the optical waveguides 11 to the optical guide regions 20. In the example illustrated in FIGS. 6A to 7C, the optical waveguides 11 are positioned on the dielectric layer 51. The dielectric layer 51 is positioned between the substrate 50b and the optical waveguides 11. By adjusting the size of the dielectric layer 51 in the Z-direction, the light propagating through each of the optical waveguides 11 can be coupled to corresponding one of the optical waveguides 10 with high efficiency. The size of the dielectric layer 51 in the Z-direction may be adjusted, for example, such that the optical waveguide 11 is positioned near a center of the optical guide region 20 in the Z-direction. The optical waveguide 11 is a waveguide through which light is to be propagated with total reflection. To that end, the refractive index of the optical waveguide 11 is higher than that of the dielectric layer 51. Note that the optical waveguide 11 may be a slow light waveguide.

Each of the optical waveguides 11 includes a portion positioned between adjacent two of the partition walls 73. As illustrated in FIGS. 6B and 7A, each optical waveguide 11 may include, in the above-mentioned portion, a grating 15 with a periodic structure along the X-direction. A propagation constant of the optical waveguide 11 is different from that of the optical waveguide 10. The propagation constant of the optical waveguide 11 is shifted by the grating 15 through an amount corresponding to a reciprocal lattice of the periodic structure. The term “reciprocal lattice of the periodic structure” indicates a value resulting from multiplying the reciprocal of the period by 2π. When the propagation constant of the optical waveguide 11 having been shifted through the amount corresponding to the reciprocal lattice matches with the propagation constant of the optical waveguide 10, the light propagating through the optical waveguide 11 is coupled to the optical waveguide 10 with high efficiency.

After affixing the upper structure body 100a and the lower structure body 100b to each other, the liquid crystal material is injected through a filling port 79o illustrated in FIG. 6B. After the injection of the liquid crystal material, the filling port 79o is closed with the same member as the sealing member 79. A region enclosed as described above is entirely filled with the liquid crystal material.

The alignment film 22 is a rubbing alignment film of which alignment direction is defined by rubbing. In a rubbing process, the alignment direction of the alignment film can be defined by rubbing the alignment film in a predetermined direction with a roll with a nylon cloth wound around the roll. The alignment film 22 is disposed on the reflecting surface 30s of the mirror 30 at the lower surface of the upper structure body 100a. The upper surface of the lower structure body 100b is in contact with the dielectric member 21 without any alignment film interposed therebetween. The reflecting surface 30s of the mirror 30 is a flat surface or an uneven surface with a difference in height of less than 1 μm. The dielectric member 21 covers the flat surface or the uneven surface. In the alignment film disposed on that surface, the alignment direction can be uniformly defined by the rubbing. The rubbing alignment film has a higher alignment restriction force than an optical alignment film described later. Accordingly, the liquid crystal material can be effectively aligned even with a configuration that the rubbing alignment film is disposed only on the reflecting surface 30s of the mirror 30.

In the optical device 100A according to this embodiment, the alignment film 22 is disposed on the reflecting surface 30s of the mirror 30 but not disposed on the reflecting surface 40s of the mirror 40. In the optical waveguide 10, therefore, even when the light propagates while repeating multiple reflections at the reflecting surface 30s and the reflecting surface 40s, the loss of the propagating light can be reduced to about half that generated in the configuration in which the rubbing alignment films are disposed at the upper and lower reflecting surfaces.

Practical examples of materials and sizes of components used in fabricating the optical device 100A according to this embodiment will be described below. In the following description, the size in the Z-direction is also referred to as a “thickness”.

Practical examples of materials and sizes of the components of the upper structure body 100a are first described.

The substrate 50a may be formed of, for example, a SiO₂ layer. The sizes of the substrate 50a in the X-direction and the Y-direction may be, for example, 8 mm and 20 mm, respectively. The thickness of the substrate 50a may be, for example, 0.7 mm.

The electrode 62a may be formed of, for example, an ITO sputtered layer. The thickness of the electrode 62a may be, for example, 50 nm.

The mirror 30 may be a multilayer reflecting film. The multilayer reflecting film may be formed, for example, by alternately vapor-depositing a Nb₂O₅ layer and a SiO₂ layer to be laminated one above another. The Nb₂O₅ layer has a refractive index n=2.282. The thickness of the Nb₂O₅ layer may be, for example, about 100 nm. The SiO₂ layer has a refractive index n=1.468. The thickness of the SiO₂ layer may be, for example, about 200 nm. The mirror 30 includes, for example, seven Nb₂O₅ layers and six SiO₂ layers, namely thirteen layers in total. The thickness of the mirror 30 may be, for example, 1.9 μm.

Examples of materials and sizes of the components of the lower structure body 100b are now described.

The substrate 50b may be formed of, for example, a SiO₂ layer. The sizes of the substrate 50b in the X-direction and the Y-direction may be, for example, each 15 mm. The thickness of the substrate 50b may be, for example, 0.7 mm.

The electrode 62b may be formed of, for example, an ITO sputtered layer. The thickness of the electrode 62b may be, for example, 50 nm.

The mirror 40 may be a multilayer reflecting film. The multilayer reflecting film may be formed, for example, by alternately vapor-depositing a Nb₂O₅ layer and a SiO₂ layer to be laminated one above another. The Nb₂O₅ layer has a refractive index n=2.282. The thickness of the Nb₂O₅ layer may be, for example, about 100 nm. The SiO₂ layer has a refractive index n=1.468. The thickness of the SiO₂ layer may be, for example, about 200 nm. The mirror 40 includes, for example, thirty-one Nb₂O₅ layers and thirty SiO₂ layers, namely sixty-one layers in total. The thickness of the mirror 40 may be, for example, 9.1 μm.

The dielectric layer 51 may be formed of, for example, a SiO₂ vapor-deposited layer. The SiO₂ vapor-deposited layer has a refractive index n=1.468. The thickness of the SiO₂ vapor-deposited layer may be, for example, about 1.0 μm.

The optical waveguide 11 may be formed of, for example, a Nb₂O₅ vapor-deposited layer. The Nb₂O₅ vapor-deposited layer has a refractive index n=2.282. The thickness of the Nb₂O₅ vapor-deposited layer may be, for example, about 300 nm. The grating 15 and a grating 13 may be formed in the optical waveguide 11. The grating 15 has a duty ratio of 1:1 and a pitch of 640 nm, for example. The grating 13 has a duty ratio of 1:1 and a pitch of 680 nm, for example. The gratings 15 and 13 may be formed by patterning with photolithography. The size of the optical waveguide 11 in the Y-direction may be, for example, 10 μm.

The partition walls 73 may be each formed of, for example, a SiO₂ vapor-deposited layer. The SiO₂ vapor-deposited layer has a refractive index n=1.468. The thickness of the SiO₂ vapor-deposited layer may be, for example, about 1.0 μm. The size of the partition wall 73 in the Y-direction may be, for example, 50 μm.

In the optical guide region 20, part of the dielectric layer 51 may be removed by, for example, patterning with photolithography. The thickness of the optical guide region 20 may be, for example, 2.0 μm. The size of the optical guide region 20 in the Y-direction may be, for example, 10 μm.

For example, a 5CB liquid crystal may be used as a material of the dielectric member 21. For example, polyimide may be used as a material of the alignment film 22. The thickness of the polyimide alignment film may be about 80 nm, and a variation of the thickness may be more than or equal to 0 nm and less than or equal to 150 nm. The polyimide alignment film is thick, and its thickness is nonuniform. When light enters the polyimide alignment film, absorption and scattering of the light occur. The polyimide alignment film may be formed by coating a polyimide solution as an alignment material over the reflecting surface 30s of the mirror 30, and by drying and curing the coated solution. Depending on a forming method, the polyimide alignment film may be additionally disposed on a surface of the upper structure body 100a other than the reflecting surface 30s of the mirror 30. Because the polyimide alignment film functions as an insulator, at least part of the electrode 62a is left exposed for supply of power without being covered with the polyimide alignment film.

For example, an Ultraviolet Curable Adhesive 3026E made by ThreeBond Co., Ltd. may be used for the sealing member 79. In an example, the sealing member 79 is cured with ultraviolet irradiation at a wavelength of 365 nm and an energy density of 100 mJ/cm², whereby the upper structure body 100a including the alignment film 22 and the lower structure body 100b are affixed to each other. With the affixing of both the structure bodies, the optical device 100A according to this embodiment is obtained.

The substrates 50a and 50b may be made of a material other than SiO₂. The substrates 50a and 50b may be each, for example, an inorganic substrate made of glass or sapphire, or a resin substrate made of acrylic or polycarbonate. The inorganic substrate and the resin substrate can be used as the substrates 50a and 50b because of having optical transparency.

The reflectance of the mirror 30 through which light is emitted is, for example, 99.9%, and the reflectance of the mirror 40 through which light is not emitted is, for example, 99.99%. Those conditions can be realized by adjusting the number of layers in the multilayer reflecting film. A combination of two types of layers in the multilayer reflecting film is, for example, that the refractive index of one layer is more than or equal to 2 and the refractive index of the other layer is less than 2. When the difference between the two refractive indexes is set to be large, a high reflectance can be obtained. The layer with the refractive index of more than or equal to 2 is made of at least one selected from the group consisting of, for example, SiNx, AlNx, TiOx, ZrOx (1.7≤x≤2.0), NbOy, and TaOy (2.2≤y≤2.5). The layer with the refractive index of less than 2 is made of, for example, at least one selected from the group consisting of SiOx and AlOx.

The refractive index of the dielectric layer 51 may be, for example, less than 2. The refractive index of each optical waveguide 11 may be, for example, more than or equal to 2. When the difference between those two refractive indexes is set to be sufficiently large, evanescent light seeping out from each optical waveguide 11 to the dielectric layer 51 can be reduced.

### Second Embodiment

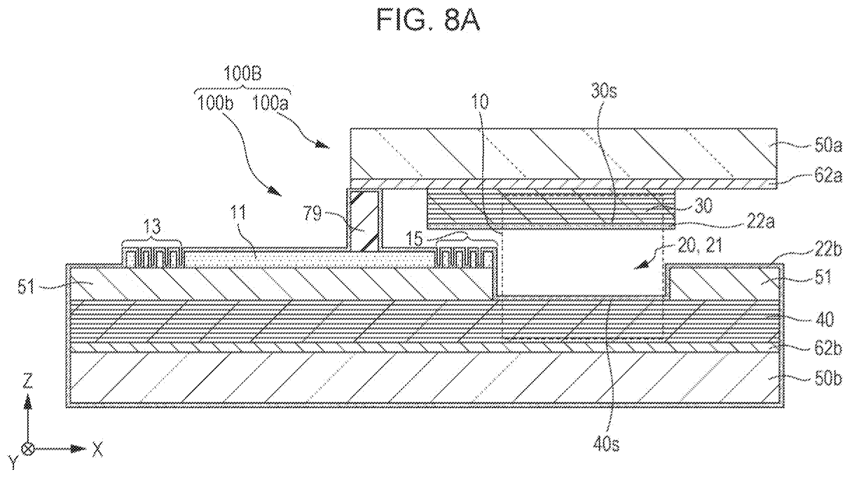

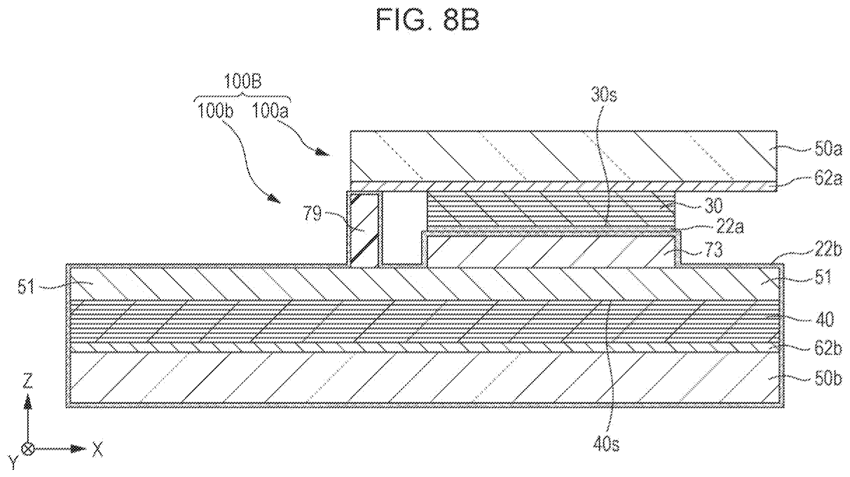

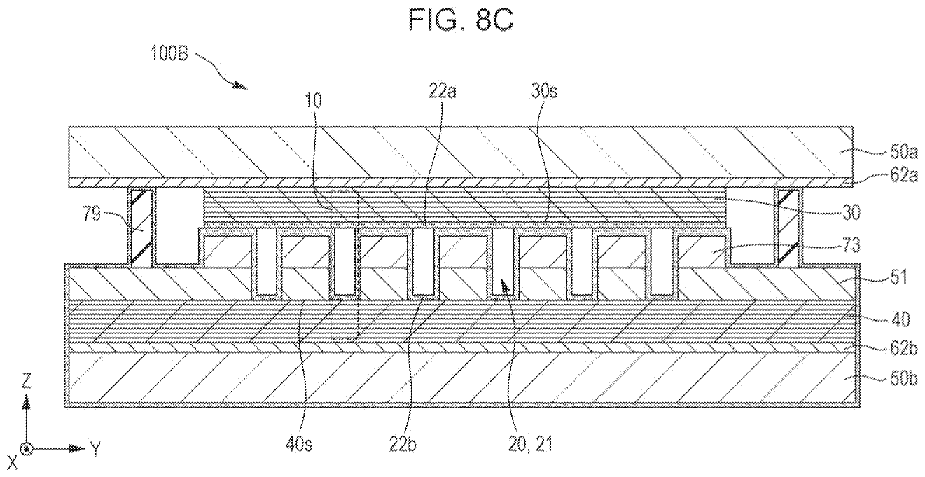

An optical device according to a second embodiment of the present disclosure will be described below with reference to FIGS. 8A to 8C. The optical device according to this embodiment is different from the optical device according to the first embodiment in that the alignment film is disposed not only the surface of the first structure body 100a, but also on the surface of the second structure body 100b. However, the alignment film disposed on the surface of the second structure body 100b is formed by a method other than the rubbing unlike the alignment film that is disposed on the surface of the first structure body 100a. In the following, the optical device according to this embodiment is described mainly about different points from the first embodiment.

FIGS. 8A to 8C are schematic sectional views illustrating an example of the optical device 100B according to this embodiment. FIGS. 8A to 8C correspond to FIGS. 7A to 7C, respectively. In other words, FIGS. 8A to 8C are sectional views corresponding to the sectional views taken along line VIIA-VIIA, line VIIB-VIIB, and line VIIC-VIIC in FIGS. 6A and 6B, respectively. A structure of the optical device 100B when viewed from the Z-direction is similar to the structure illustrated in FIG. 6A except that the alignment film is disposed on the surface of the lower structure body 100b as well. In an example illustrated in FIGS. 8A to 8C, the upper structure body 100a includes a first alignment film 22a of the same structure as the above-described alignment film 22. On the other hand, the lower structure body 100b includes a second alignment film 22b that is formed by a method other than the rubbing. The second alignment film 22b is disposed on an upper surface, a lower surface, and a side surface of the lower structure body 100b. In more detail, the second alignment film 22b is disposed on parts of respective surfaces of the substrate 50b, the mirror 40, the dielectric layer 51, the partition walls 73, the sealing member 79, and the optical waveguides 11, those parts being exposed if the second alignment film 22b is not present.

The second alignment film 22b in this embodiment is an alignment film other than the rubbing alignment film. The second alignment film 22b may be, for example, an optical alignment film of which alignment direction is defined by irradiation with polarized light. The second alignment film 22b may be, for example, a film bonded to the surface of the second structure body 100b through a siloxane bond interposed therebetween, more specifically, a monomolecular alignment film. The siloxane bond increases adhesivity and coverage of the monomolecular film. The monomolecular alignment film can be fabricated at a low cost. In the example illustrated in FIGS. 8A to 8C, the second alignment film 22b is disposed on the other surfaces as well than the reflecting surface 40s of the mirror 40 in the lower structure body 100b for convenience in fabrication of the optical device 100B. However, the second alignment film 22b is not always required to be disposed on the other surfaces as well than the reflecting surface 40s of the mirror 40 in the lower structure body 100b.

As described above, the upper surface of the lower structure body 100b has the recesses with the depth of greater than or equal to 1 μm and smaller than or equal to 10 μm. The dielectric member 21 fills the recesses. It is not easy to form, on the surface of the second structure body 100b including the above-mentioned recesses, the rubbing alignment film to align the liquid crystal material in a particular direction. The protrusions on both the sides of each recess may become obstacles in the rubbing, and unevenness may be caused in the alignment direction. Moreover, there is a possibility that the protrusions may be destroyed during the rubbing and the function of the protrusions forming the waveguides in the optical guide regions 20 may be impaired. On the other hand, when the second alignment film 22b is formed by the irradiation with the polarized light, the second alignment film 22b to align the liquid crystal material in the particular direction can be easily formed. The protrusions desirably do not have a shape intercepting the irradiation of the alignment film with the polarized light. Such a shape may be, for example, a reverse-tapered shape with a width gradually increasing at a location farther away from the reflecting surface 40s of the mirror 40.

The monomolecular alignment film is thinner and more uniform in thickness than the polyimide alignment film. The thickness of the monomolecular alignment film is about 2 nm, namely a molecule size. Even with light entering the thin and uniform monomolecular alignment film, absorption and scattering of the light hardly occurs. Accordingly, when light propagates in the optical guide region 20 in the X-direction with multiple reflections as illustrated in FIG. 2, the light is hardly absorbed and scattered by the monomolecular alignment film. As a result, the loss of the propagating light can be suppressed.

Because the second alignment film 22b is thin and does not function as an insulating film, there is no problem even if the second alignment film 22b disposed on the other surfaces than the reflecting surface 40s of the mirror 40 is left there. Accordingly, a step of removing the second alignment film 22b can be omitted in the fabrication of the optical device 100B. Depending on applications, the second alignment film 22b disposed on the other surfaces than the reflecting surface 40s of the mirror 40 may be removed.

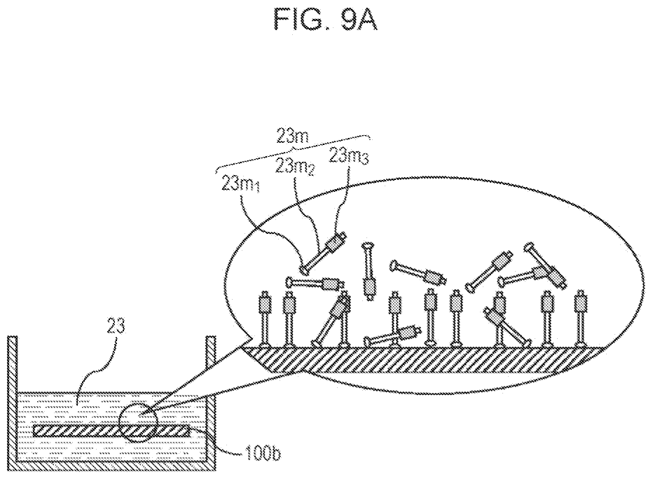

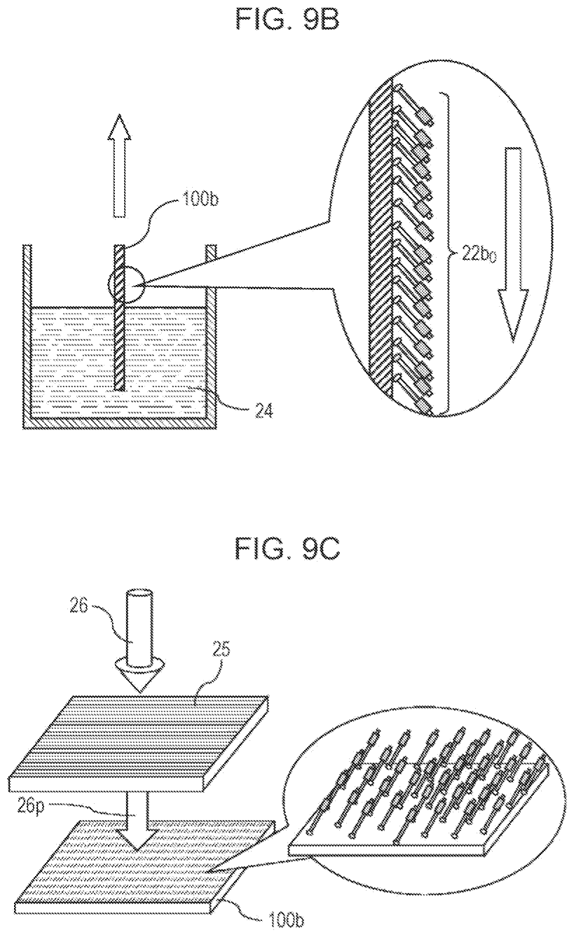

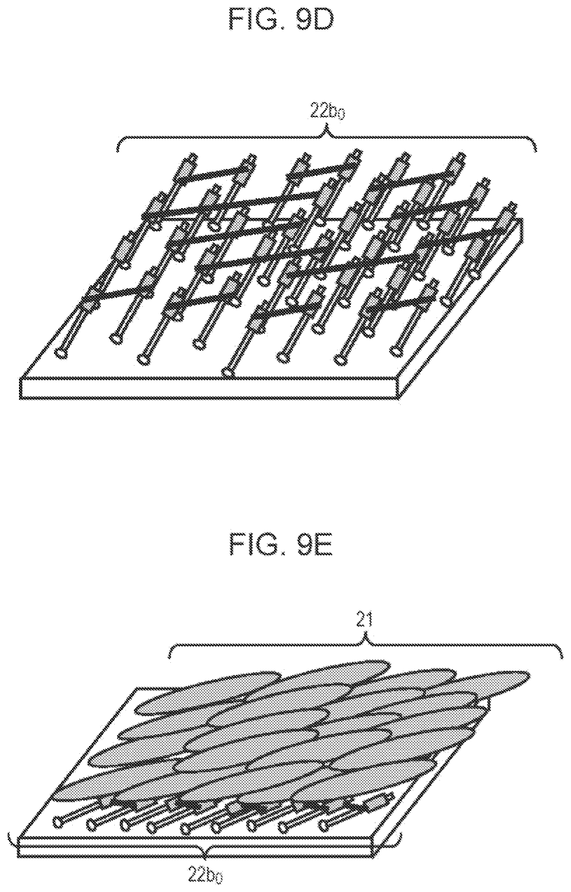

Practical examples of a material of the second alignment film 22b and a method of forming the second alignment film 22b will be described below with reference to FIGS. 9A to 9E. FIGS. 9A to 9E are explanatory views illustrating an example of the second alignment film 22b in the second embodiment.

FIG. 9A schematically illustrates a state in which the lower structure body 100b is dipped in a solution 23 containing at least a silane compound. As illustrated in FIG. 9A, the solution 23 containing at least the silane compound is brought into contact with the lower structure body 100b, thus causing the silane compound to be chemically adsorbed on the lower structure body. As a result, a film bonded to the lower structure body through a siloxane bond interposed therebetween is formed. In a molecule 23m illustrated in FIG. 9A, an elliptic portion 23m₁ represents the siloxane bond, a thin and long portion 23m₂ represents a carbon-hydrogen bond, and a thick and short portion 23m₃ represents other bonds.

Then, as illustrated in FIG. 9B, the excessive silane compound not chemically adsorbed is dissolved into a cleaning liquid 24 and is removed. As a result, the above-mentioned film becomes a monomolecular film 22b₀ bonded through the siloxane bond. The monomolecular film 22b₀ functions as the above-described second alignment film 22b.

The alignment direction of the monomolecular film 22b₀ is determined as follows. The monomolecular film 22b₀ can be aligned, as illustrated in FIG. 9B, by draining the cleaning liquid 24 off. An arrow facing upward represents a direction in which the lower structure body 100b is lifted up, and an arrow facing downward represents the alignment direction.

Alternatively, when the monomolecular film 22b₀ bonded through the siloxane bond contains a photosensitive group, the photosensitive group is cross-linked or polymerized as illustrated in FIG. 9D by irradiating, as illustrated in FIG. 9C, the monomolecular film 22b₀ with polarized light 26p that is obtained by causing a non-polarized ultraviolet ray 26 to pass through a polarizer 25. In FIG. 9D, a thick line represents cross-linking. As a result of the irradiation with the polarized light 26p, the monomolecular film 22b₀ becomes a monomolecular alignment film exhibiting uniform alignment anisotropy for a liquid crystal. Furthermore, a monomolecular film exhibiting the uniform alignment anisotropy can also be obtained by rubbing a surface of the monomolecular film bonded through the siloxane bond.

Whether an alignment process for the alignment film has been performed by the draining-off or the irradiation with the polarized light or by the rubbing can be known depending on whether there are scratches on the alignment film. The draining-off or the irradiation with the polarized light causes no scratches on the alignment film. On the other hand, the rubbing causes the scratches on the alignment film.

As illustrated in FIG. 9E, a liquid crystal material 21 made up of rod-like molecules is aligned in a particular direction by the monomolecular alignment film 22b₀.

The above-described solution 23 containing the silane compound is a solution that the silane compound is dissolved in a solvent (or dissolvent). However, the solution 23 may be in a state in which part of the silane compound is not dissolved. A typical example of that type of solution is a solution in a supersaturated state.

Practical examples of the silane compound, which can be used in the above-described method of fabricating the second alignment film 22b, are listed in (1) to (5) given below.

SiYₚCl₃₋ₚ (1)

CH₃—(CH₂)ᵣSiY_{q}Cl_{3-q} (2)

CH₃(CH₂)ₛO(CH₂)ₜSiY_{q}Cl_{3-q} (3)

CH₃(CH₂)ᵤ—Si(CH₃)₂(CH₂)ᵥ—SiY_{q}Cl_{3-q} (4)

CF₃COO(CH₂)_{w}SiY_{q}Cl_{3-q} (5)

In the above formulae, p denotes an integer from 0 to 3, q denotes an integer from 0 to 2, r denotes an integer from 1 to 25, s denotes an integer from 0 to 12, t denotes an integer from 1 to 20, u denotes an integer from 0 to 12, v denotes an integer from 1 to 20, and w denotes an integer from 1 to 25. Y denotes one selected from the group consisting of hydrogen, an alkyl group, an alkoxyl group, a fluorine-containing alkyl group, and a fluorine-containing alkoxyl group.

Practical examples of a trichlorosilane compound are listed in (6) to (14) given below.

CF₃(CH₂)₉SiCl₃ (6)

CH₃(CH₂)₉OSiCl₃ (7)

CH₃(CH₂)₉Si(CH₃)₂(CH₂)₁₀SiCl₃ (8)

CH₃COO(CH₂)₁₅SiCl₃ (9)

CF₃(CF₂)₇—(CH₂)₂—SiCl₃ (10)

CF₃(CF₂)₇—C₆H₄—SiCl₃ (11)

C₆H₅—CH═CH—CO—O—(CH₂)₆—O—SiCl₃ (12)

C₆H₅—CO—CH═CH—C₆H₄—O—(CH₂)₆—O—SiCl₃ (13)

C₆H₅—CH═CH—CO—C₆H₄—O—(CH₂)₆—O—SiCl₃ (14)

The compound (12) has a photosensitive cinnamoyl group. The compounds (13) and (14) each have a photosensitive chalconyl group. Photosensitive group portions are polymerized upon irradiation with an ultraviolet ray. Furthermore, an isocyanate silane compound obtained by replacing a chlorosilyl group with an isocyanate group, or an alkoxy silane compound obtained by replacing a chlorosilyl group with an alkoxy group may be used instead of the above-described chlorosilane compound.

For example, an isocyanate silane compound (15) or an alkoxy silane compound (16), given below, may be used instead of the chlorosilane (6).

CH₃(CH₂)₉Si(OC₂H₅)₃ (15)

CH₃(CH₂)₉Si(NCO)₃ (16)

Using the isocyanate silane compound or the alkoxy silane compound is advantageous in that, because no hydrochloric acid is generated with chemical bonding thereof, a device is not damaged, and work is easier to perform.

An example of a process of forming a thin film on a substrate surface with a silane compound and examples of a solvent and a substrate used in the process will be described below.

The following chemical formula (1) represents reaction steps when the compound CF₃—(CF₂)₇—(CH₂)₂—SiCl₃ denoted in above (10) is used as the silane compound and is brought into contact with a glass substrate.

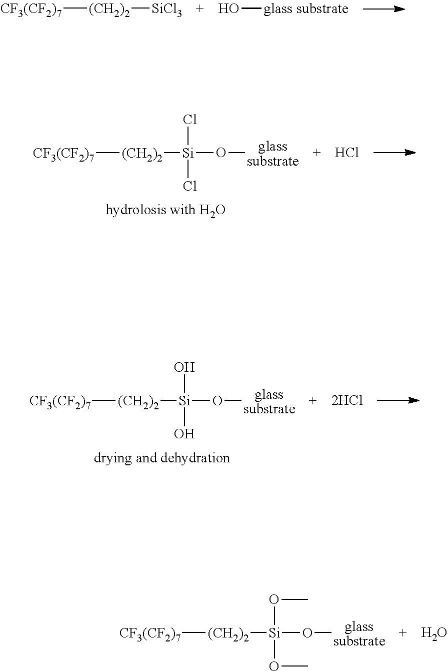

A first dehydrochlorination reaction denoted in the chemical formula (1) is a chemical adsorption reaction. When a silane compound solution is brought into contact with the glass substrate having an OH group, the dehydrochlorination reaction occurs. With the dehydrochlorination reaction, one end of the silane compound is chemically bonded to an OH group portion in a substrate surface. That reaction is a reaction between a SiCl group in the silane compound and the OH group. When the silane compound solution contains a large amount of water, the reaction with the substrate is impeded. To smoothly promote the reaction, therefore, it is desired to use a nonaqueous solvent not containing active hydrogen such as the OH group and to progress the reaction in an atmosphere with low humidity. Details of a humidity condition will be described later. Thereafter, through hydrolysis with H₂O, drying, and dehydration, the film bonded through the siloxane bond is formed on the surface of the glass substrate.

A solvent capable of being used in this embodiment for the silane compound may be, for example, at least one selected from the group consisting of a hydrocarbon solvent, a carbon fluoride solvent, and a silicone solvent each containing no water. A petroleum solvent capable of being used in this embodiment may be, for example, at least one selected from the group consisting of petroleum naphtha, solvent naphtha, petroleum ether, petroleum benzine, isoparaffin, normal paraffin, decalin, industrial gasoline, kerosene, ligroin, dimethyl silicone, phenyl silicone, alkyl-denatured silicone, and polyester silicone. The carbon fluoride solvent capable of being used in this embodiment may be at least one selected from the group consisting of a fluorocarbon solvent, Fluorinert (made by 3M Company), and Afluid (made by Asahi Glass Co., Ltd.). The above-mentioned solvents may be used alone or in a combination of two or more that are compatible with each other.

Particularly, silicone contains very little water and is less hygroscopic. Moreover, the silicone is solvated with the chlorosilane compound and acts to prevent the chlorosilane compound from coming into direct contact with water. Accordingly, by bringing a solution of the chlorosilane compound and the silicone into contact with an underlying layer, the chlorosilane compound can be chemically adsorbed on the OH group exposed to the underlying layer while an adverse effect of moisture in an ambient atmosphere is prevented.

In consideration of that the second alignment film 22b is to be disposed, respective materials of the optical waveguide 11, the mirrors 30 and 40, the dielectric layer 51, and the partition wall 73 in the optical device 100B may be given, by way of example, as follows. Among those materials, the material with a refractive index of more than or equal to 2 is at least one selected from the group consisting of SiNx, AlNx, TiOx, ZrOx, NbOy, and TaOy. Among those materials, the material with a refractive index of less than 2 is at least one selected from the group consisting of SiOx and AlOx. The above-mentioned materials can provide many OH groups serving as adsorption sites for the silane compounds. Accordingly, the alignment film with a good alignment characteristic can be formed on surfaces of those materials.

On the other hand, the electrode 62b in the optical device 100B may be made of at least one conductive material selected from the group consisting of ITO and Al. The sealing member 79 in the optical device 100B may be made of an acrylic or silicone polymer material. The above-mentioned conductive materials and polymer materials contain few OH groups serving as the adsorption sites for the silane compounds. Therefore, when the alignment film is to be formed on surfaces of the above-mentioned materials as well, hydrophilization for producing or increasing the OH groups are carried out on those surfaces. As the hydrophilization, it is effective to form a SiO₂ film or a SiNₓ film on the surfaces, or to produce the OH groups on the surfaces with UV-03 treatment.

For example, dipping and vapor cleaning are used as cleaning methods in this embodiment. Particularly, the vapor cleaning can strongly remove, with osmotic power of vapor, the excessive silane compounds that are not chemically adsorbed and that remain on all the surfaces of the lower structure body 100b. A cleaning solvent capable of being used in this embodiment may be, for example, at least one selected from the group consisting of a hydrocarbon solvent, a carbon fluoride solvent, and a silicone solvent each containing no water. A petroleum cleaning solvent capable of being used in this embodiment may be, for example, at least one selected from the group consisting of petroleum naphtha, solvent naphtha, petroleum ether, petroleum benzine, isoparaffin, normal paraffin, decalin, industrial gasoline, kerosene, ligroin, dimethyl silicone, phenyl silicone, alkyl-denatured silicone, and polyester silicone. The carbon fluoride solvent capable of being used in this embodiment may be at least one selected from the group consisting of a fluorocarbon solvent, Fluorinert (made by 3M Company), and Afluid (made by Asahi Glass Co., Ltd.). The above-mentioned solvents (or dissolvents) may be used alone or in a combination of two or more that are compatible with each other.

As an alignment method with the draining-off, there is a method of, as illustrated in FIG. 9B, holding the surface of the lower structure body 100b to stand in a vertical direction and draining the cleaning liquid off. This enables the cleaning liquid to be drained off only in the vertical direction. Particularly, the draining-off of the cleaning liquid with the boiling point of lower than or equal to 200° C. is superior in drying property after the draining-off. Furthermore, chloroform is superior in performance of removing a chlorosilane polymer that is generated by a reaction between chlorosilane and water.

As the alignment method with the draining-off, there is also a method of spraying gas to the surface of the lower structure body 100b, thereby draining the cleaning liquid off. This enables the cleaning liquid to be drained off in a short time only in a direction in which the gas is sprayed. Particularly, in the draining-off of the cleaning liquid with the boiling point of higher than or equal to 150° C., the cleaning liquid is not evaporated even with the spraying of the gas. Furthermore, N-methyl-2pyrrolidinone is superior in performance of removing the chlorosilane polymer that is generated by the reaction between chlorosilane and water.

A polarized ultraviolet ray for use in the alignment by the irradiation with the polarized light, that alignment being applicable to this embodiment, may have a wavelength distribution of, for example, longer than or equal to about 300 nm and shorter than or equal to about 400 nm. An irradiation dose of the polarized ultraviolet ray is, for example, greater than or equal to about 50 mJ/cm² and smaller than or equal to about 2000 mJ/cm² at 365 nm. Particularly, at the irradiation dose of greater than or equal to 1000 mJ/cm², the alignment of the liquid crystal material tends to become homogeneous alignment. On the other hand, at the irradiation dose of smaller than 100 mJ/cm², the alignment of the liquid crystal material tends to become pre-tilt alignment.

### EXAMPLES

An effect of reducing, in the first embodiment and the second embodiment, a deviation in the alignment direction of the liquid crystal material contained in the dielectric member 21 will be described below. The deviation in the alignment direction of the liquid crystal material can be known by measuring the retardation of a liquid crystal cell. Because of being optically isotropic, the liquid crystal material has a fast axis in which a phase of light advances and a slow axis in which a phase of light delays. The deviation in the alignment direction of the liquid crystal material is determined depending on an angle formed between a direction of the alignment process and a direction of the slow axis of the liquid crystal material. In a comparative example in which the monomolecular alignment film having the siloxane bond was disposed on the reflecting surface 30s of the mirror 30, but no alignment film was disposed on the upper surface of the lower structure body 100b, the alignment direction of the liquid crystal material was deviated 0.5 degree from the desired direction. By contrast, in the optical device 100A according to the first embodiment, the deviation in the alignment direction of the liquid crystal material was reduced to 0.1 degree by using the alignment film 22 formed as the polyimide alignment film (namely, the rubbing alignment film). This is because the polyimide alignment film has a higher alignment restriction force than the monomolecular alignment film. In the optical device 100B according to the second embodiment, the deviation in the alignment direction of the liquid crystal material was reduced to 0.05 degree by using both the first alignment film 22a formed as the polyimide alignment film and the second alignment film 22b formed as the optical alignment film. The above result proves that the deviation in the alignment direction of the liquid crystal material 21 can be more uniformly aligned due to the presence of the optical alignment film in addition to the polyimide alignment film.

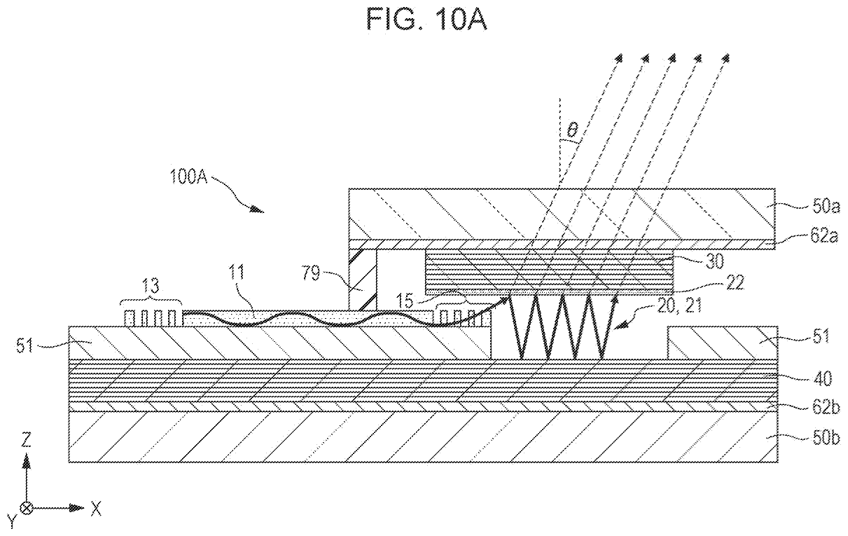

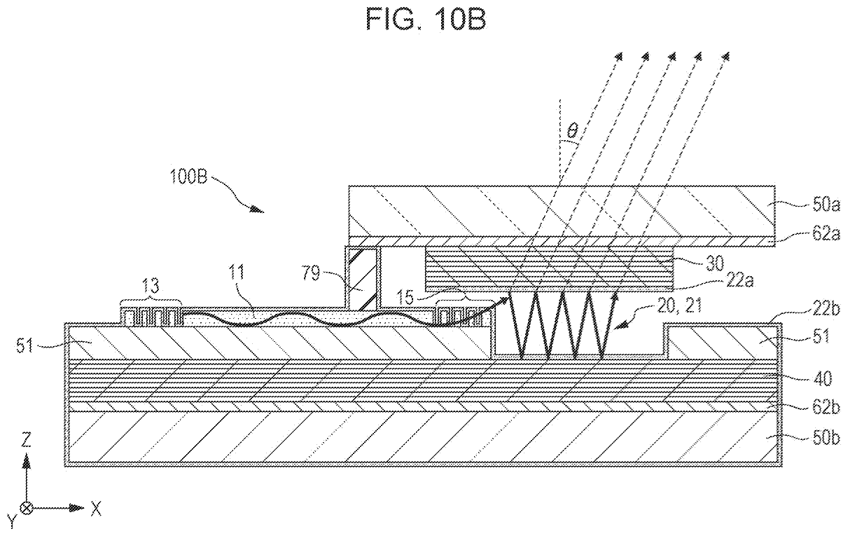

An effect of reducing the loss of light emitted from the optical device 100A according to the first embodiment and the optical device 100B according to the second embodiment will be described below with reference to FIGS. 10A and 10B. FIG. 10A is a schematic view illustrating a situation in which light is emitted from the optical device 100A according to the first embodiment. FIG. 10B is a schematic view illustrating a situation in which light is emitted from the optical device 100B according to the second embodiment. In Examples illustrated in FIGS. 10A and 10B, the intensity of the light emitted from each of the optical device 100A and the optical device 100B was measured by an optical detector (not illustrated) fixedly held in a direction of an exit angle θ=60°. In the measurement, a laser beam of 589 nm was input to each optical waveguide 11 through the grating 13. The loss of the emitted light was calculated on the basis of the intensity of light emitted from a device with a configuration not including any alignment film.

In a comparative example with a configuration including the polyimide alignment film disposed on each of the reflecting surface 30s of the mirror 30 and the upper surface of the lower structure body 100b, the loss of the emitted light was about 50%. By contrast, the loss of the emitted light was reduced to about 25% in the Example illustrated in FIG. 10A. The loss of the emitted light was also reduced to about 25% in the Example illustrated in FIG. 10B.

The polyimide alignment film is often used in a liquid crystal display. In the liquid crystal display, light passes through alignment films on both upper and lower substrates only once. Accordingly, even with the polyimide alignment film being thick and not uniform in thickness, light loss caused by absorption and scattering in the alignment films does not substantially raise the problem with one passage of the light.

On the other hand, in the optical device 100A according to the first embodiment and the optical device 100B according to the second embodiment, as described above, the light propagates in the optical guide region 20 while repeating multiple reflections at the reflecting surface 30s of the mirror 30 and the reflecting surface 40s of the mirror 40. In the configuration including the polyimide alignment films disposed on both the reflecting surfaces, therefore, the light loss caused by the absorption and the scattering in the alignment films becomes nonnegligible. To solve the above-mentioned problem, in each of the optical device 100A according to the first embodiment and the optical device 100B according to the second embodiment, the polyimide alignment film is disposed on the reflecting surface 30s of the mirror 30 but not disposed on the upper surface of the lower structure body 100b. With such a structure, the light loss can be reduced to about half. Particularly, in the optical device 100B according to the second embodiment, since the second alignment film 22b is formed as the optical alignment film, the alignment direction of the liquid crystal material 21 can be more uniformly aligned without substantially causing the light loss in the second alignment film 22b.

### Modification

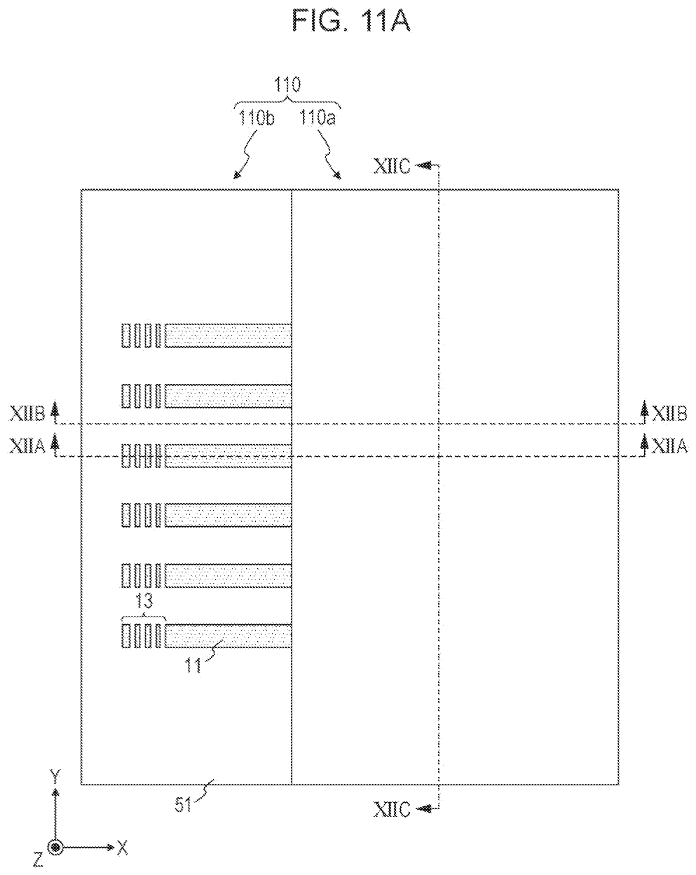

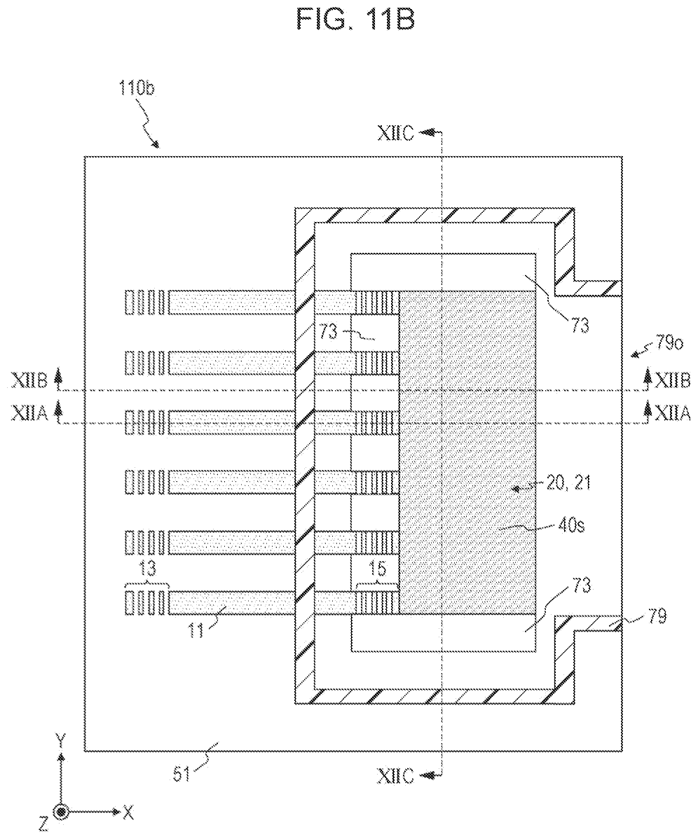

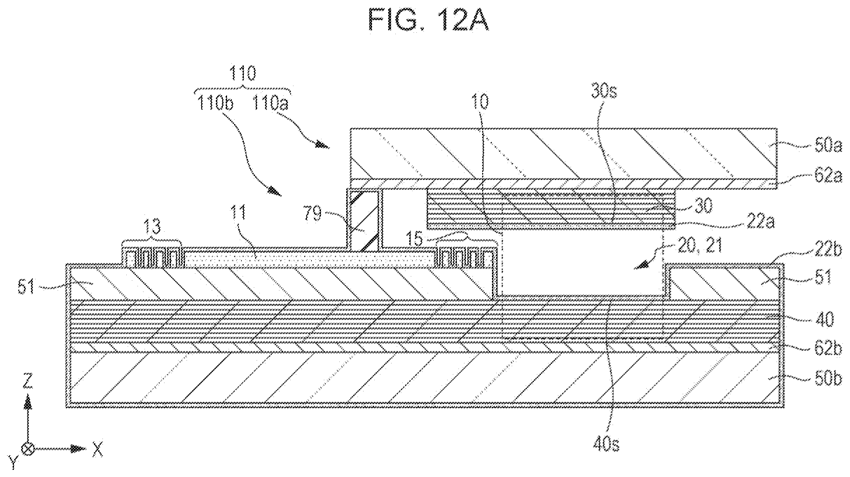

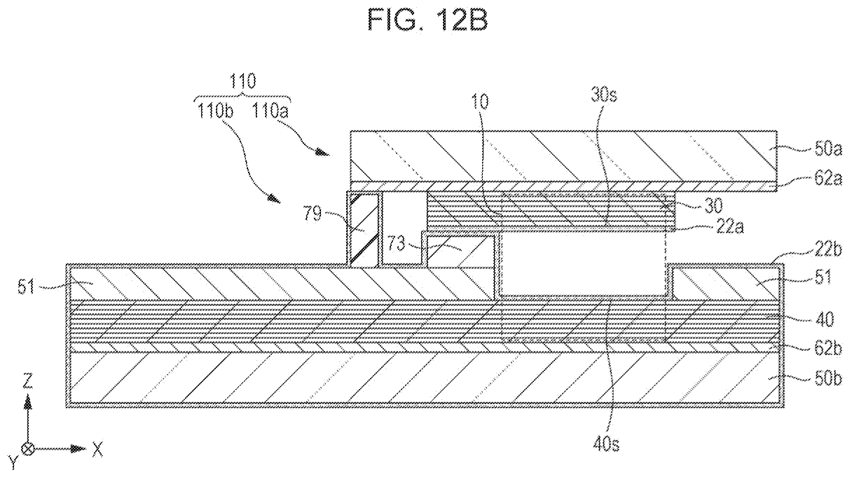

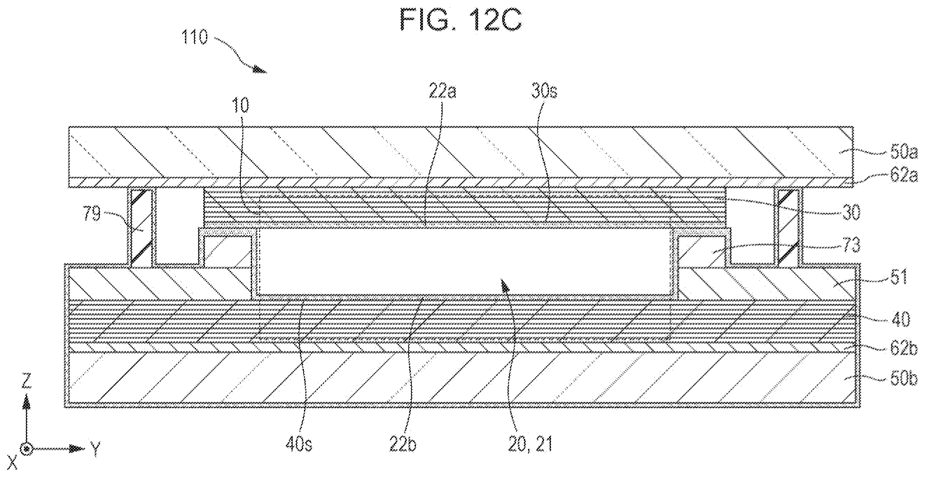

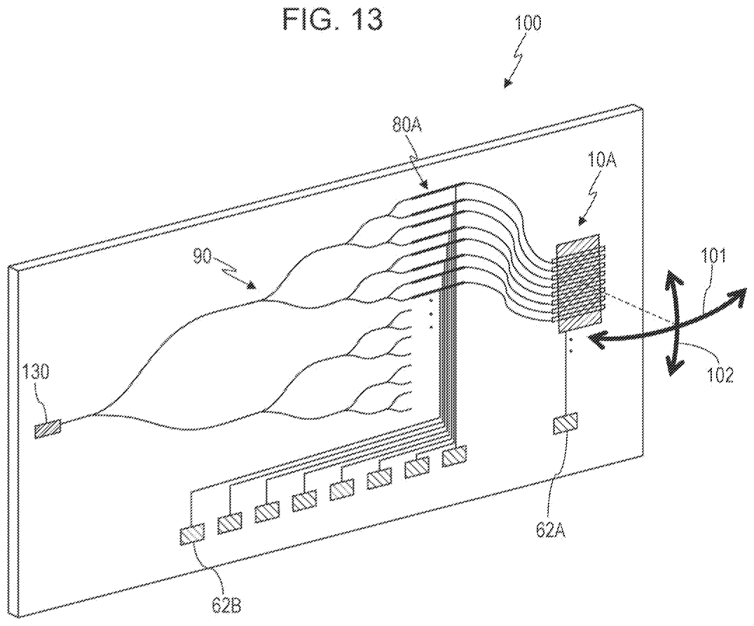

In the optical device 100A according to the first embodiment and the optical device 100B according to the second embodiment, the multiple optical guide regions 20 arrayed in the Y-direction are disposed. However, the provision of the multiple optical guide regions 20 is not essential, and one optical guide region 20 may be disposed instead. That one optical guide region 20 may be, for example, a planar optical waveguide. A modification of the optical device 100B according to the second embodiment will be described below with reference to FIGS. 11A to 12C. The modification described below can be applied to the optical device 100A according to the first embodiment as well. The optical device 100B according to the second embodiment and the optical device 100A according to the first embodiment are different only in whether the second alignment film 22b is disposed. FIG. 11A is a schematic view illustrating an example of an optical device 110 according to this modification when viewed from the Z-direction. Note that, in FIG. 11A, the second alignment film 22b is omitted. FIG. 11B illustrates a state in which the upper structure body 100a is excluded from a structure illustrated in FIG. 11A. FIGS. 12A, 12B, and 12C are sectional views taken along lines XIIA-XIIA, XIIB-XIIB, and XIIC-XIIC in FIGS. 11A and 11B, respectively.

An upper structure body 110a in this modification has the same structure as the upper structure body 100a in the second embodiment. On the other hand, a lower structure body 110b in this modification is different from the lower structure body 100b in the second embodiment in that, as illustrated in FIG. 11B, two partition walls 73 are arranged at both sides of the one optical guide region 20. As illustrated in FIGS. 12A to 12C, the lower structure body 110b has a recess with a relatively large width. With such a structure, the reflecting surface 40s of the mirror 40 is exposed over a relatively wide area along the X-direction and the Y-direction. As illustrated in FIG. 12C, the recess is positioned between two protrusions extending in the X-direction. In the illustrated example, the planar optical waveguide is formed by the reflecting surface 30s of the mirror 30, the reflecting surface 40s of the mirror 40, and the one optical guide region 20 positioned between both the reflecting surfaces and spreading in the X-direction and the Y-direction. The optical guide region 20 is surrounded by the reflecting surface 30s of the mirror 30, the reflecting surface 40s of the mirror 40, and the two protrusions each formed by the partition wall 73. The optical guide region 20 is filled with the dielectric member 21 including the liquid crystal material.

As illustrated in FIG. 11B, the optical waveguides 11 are connected to the optical guide region 20 in the planar optical waveguide 10. Lights propagating through the optical waveguides 11 are coupled to the optical guide region 20. The coupled lights interfere with each other within the optical guide region 20 and form a light beam. The light beam formed within the optical guide region 20 is emitted to the outside through the mirror 30, the electrode 62a, and the substrate 50a. The optical device 110 according to the modification can also change respective components of a wave vector of the emitted light in the X-direction and the Y-direction.

In the above example, because of the influence of a step portion at an edge of the recess, good alignment performance cannot be realized particularly in the step portion when the second alignment film 22b is formed by the rubbing. To solve that problem, the second alignment film 22b is formed by a method without resorting to the rubbing, such as the irradiation with the polarized light. As a result, the second alignment film 22b with good alignment performance in the step portion as well can be formed.

In the first and second embodiments, the Examples, and the modification, the optical waveguide 10 is the slow light waveguide. However, the optical waveguide 10 does not need to be the slow light waveguide. For example, the optical waveguide 10 may be an optical waveguide that does not include the mirrors 30 and 40 and that causes light to propagate in the optical guide region 20 with total reflection at the surface of the substrate 50a and the surface of the substrate 50b. The light propagating through the above-mentioned optical waveguide may be emitted to the outside from, for example, an end portion of the optical waveguide 10 instead of passing through the substrate 50a or the substrate 50b.

In the first and second embodiments, the Examples, and the modification, the alignment films 22, 22a, and 22b are functional films for causing the liquid crystal material contained in the dielectric member 21 to be aligned in the particular direction. Instead of or in addition to those alignment films, various other functional films may be optionally disposed depending on other specific purposes or applications. For example, a functional film with at least one of properties, such as heat resistance, scratch resistance, stickiness, light transparency, light shielding, flexibility, rigidity, electrical conductivity, and insulation, may be disposed. The dielectric member 21 is not limited to the liquid crystal material and may contain a material suitable for the performance of the functional film.

### Application Examples

### Example of Application to Optical Scanning Device

FIG. 13 illustrates an example of configuration of the optical scanning device 100 in which individual elements, such as the optical demultiplexer 90, the waveguide array 10A, the phase shifter array 80A, and a light source 130, are integrated on a circuit board (for example, a chip). The optical scanning device 100 includes the optical devices according to the first and second embodiments and the modification. The light source 130 may be, for example, a light emitting element such as a semiconductor laser. The light source 130 in the illustrated example emits light of a single wavelength, the light having a wavelength λ in a free space. The optical demultiplexer 90 demultiplexes the light from the light source 130 and introduces the demultiplexed lights to waveguides in the phase shifters. In the example illustrated in FIG. 13, one electrode 62A and multiple electrodes 62B are disposed on the chip. A control signal is supplied from the electrode 62A to the waveguide array 10A. Control signals are supplied from the electrodes 62B to the phase shifters 80 in the phase shifter array 80A. The electrode 62A and the electrodes 62B may be connected to a control circuit (not illustrated) that generates the above-mentioned control signals. The control circuit may be disposed on the chip illustrated in FIG. 13 or on another chip in the optical scanning device 100.

With all components integrated on one chip as illustrated in FIG. 13, a light scan over a wide range can be realized with a small device. All the components illustrated in FIG. 13 can be integrated on a chip with a size of about 2 mm×1 mm, for example.

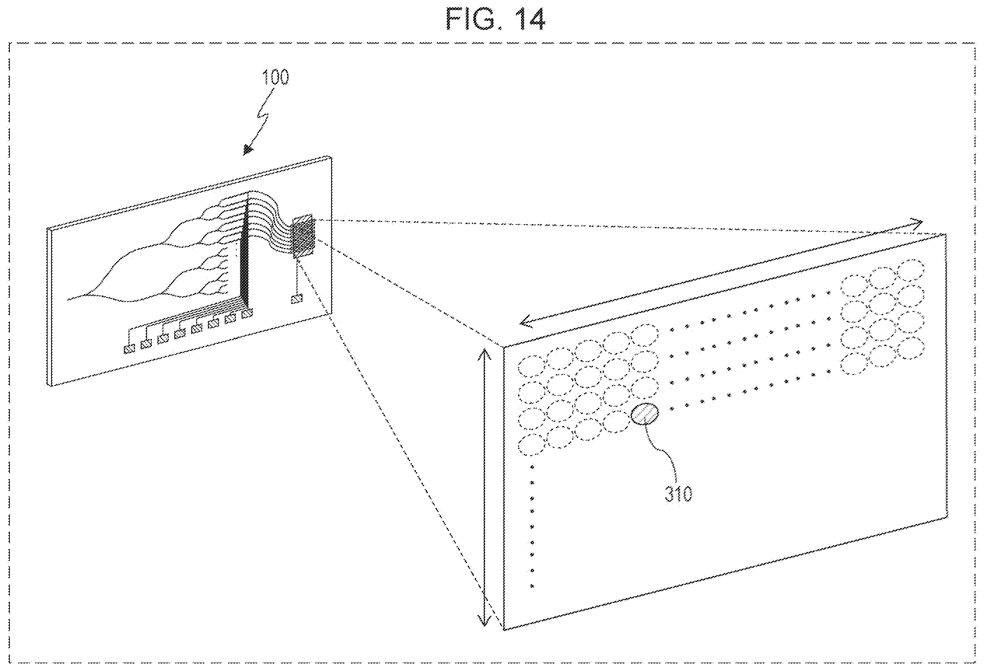

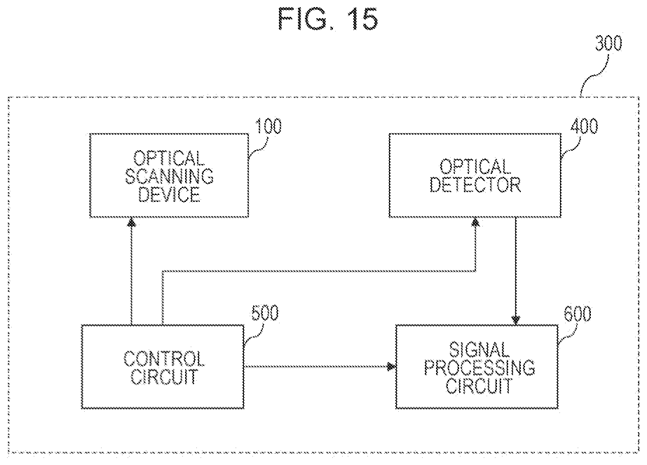

FIG. 14 is a schematic view illustrating a situation in which a two-dimensional scan is performed by emitting a light beam, such as a laser beam, to a far field from the optical scanning device 100. The two-dimensional scan is performed by moving a beam spot 310 in the horizontal and vertical directions. For example, a two-dimensional distance measurement image can be obtained by combining the optical scanning device 100 with a known TOF (Time Of Flight) method. The TOF method is a method of emitting the laser beam to an object, observing reflected light from the object, calculating a flight time of the light, and determining a distance to the object.

FIG. 15 is a block diagram illustrating an example of configuration of a LiDAR system 300 that is an example of an optical detection system capable of creating the above-described distance measurement image. The LiDAR system 300 includes the optical scanning device 100, an optical detector 400, a signal processing circuit 600, and a control circuit 500. The optical detector 400 detects the light emitted from the optical scanning device 100 and reflected from the object. The optical detector 400 may be a photodetector including a light receiving element, such as an image sensor or a photodiode, with sensitivity for the wavelength λ of the light emitted from the optical scanning device 100. The optical detector 400 outputs an electric signal corresponding to an amount of the received light. The signal processing circuit 600 calculates the distance to the object based on the electric signal output from the optical detector 400 and creates distance distribution data. The distance distribution data is data representing a two-dimensional distribution of the distance (namely, a distance measurement image). The control circuit 500 is a processor that controls the optical scanning device 100, the optical detector 400, and the signal processing circuit 600. The control circuit 500 controls the timing of exiting of the light beam from the optical scanning device 100, the exposure timing of the optical detector 400, and the timing of reading the signal therefrom, and instructs the signal processing circuit 600 to create the distance measurement image.

A frame rate used in the two-dimensional scan to obtain the distance measurement image can be selected from, for example, 60 fps, 50 fps, 30 fps, 25 fps, 24 fps, and so on which are commonly used to obtain moving images. In consideration of an application to an on-vehicle system, as the frame rate increases, a frequency of obtaining the distance measurement image increases and an obstacle can be detected with higher accuracy. For example, when a vehicle with the frame rate of 60 fps runs at 60 km/h, the image can be obtained each time the vehicle moves about 28 cm. When the frame rate is 120 fps, the image can be obtained each time the vehicle moves about 14 cm. When the frame rate is 180 fps, the image can be obtained each time the vehicle moves about 9.3 cm.

A time required to obtain one distance measurement image depends on the speed of a beam scan. For example, to obtain an image with the number of resolution points of 100×100 at the frame rate of 60 fps, the beam scan needs to be performed in time shorter than or equal to 1.67 μs. In that case, the control circuit 500 controls the exiting of the light beam from the optical scanning device 100 and accumulation and read of signals by and from the optical detector 400 at an operating speed of 600 kHz.

### Application Example to Light Receiving Device

The optical scanning device or the optical device according to each of the above-described embodiments of the present disclosure can also be used as a light receiving device with substantially the same configuration. The light receiving device includes the same waveguide array 10A as that in the optical scanning device and a first adjuster for adjusting a direction in which light is receivable. Each first mirror 30 in the waveguide array 10A allows light incident on a side opposite to the first reflecting surface from the third direction to pass therethrough. Each optical guide layer 20 in the waveguide array 10A allows the light having passed through the first mirror 30 to propagate in the second direction. The first adjuster can change the direction in which light is taken into the optical guide layer 20 and is receivable by changing at least one of the refractive index or the thickness of the optical guide layer 20 in each waveguide element 10 or the light wavelength. When the light receiving device further includes the same phase shifters 80 as those in the optical scanning device and second adjusters each changing a phase difference between the lights output from the waveguide elements 10 after passing through the phase shifters 80, the direction in which light is receivable can be two-dimensionally changed.

For example, the light receiving device can be constituted as a light receiving device in which the light source 130 in the optical scanning device 100 illustrated in FIG. 13 is replaced with a receiving circuit. When lights of the wavelength λ are incident on the waveguide array 10A, the lights are sent to the optical demultiplexer 90 through the phase shifter array 80A and are finally collected to one location to be sent to the receiving circuit. It can be said that the intensity of the lights collected to the one location represents sensitivity of the light receiving device. The sensitivity of the light receiving device can be adjusted with adjusters that are separately incorporated in the waveguide array 10A and the phase shifter array 80A. Referring to FIG. 4, for example, the direction of the wave vector (denoted by the thick arrow in FIG. 4) is reversed in the light receiving device. The incident light has a light component in the direction in which the waveguide elements 10 extend (namely, in the X-direction in FIG. 4) and a light component in the direction in which the waveguide elements 10 are arrayed (namely, in the Y-direction in FIG. 4). The sensitivity for the light component in the X-direction can be adjusted with the adjuster incorporated in the waveguide array 10A. On the other hand, the sensitivity for the light component in the array direction of the waveguide elements 10 can be adjusted with the adjuster incorporated in the phase shifter array 80A. θ and α₀ illustrated in FIG. 4 can be determined from the phase difference Δφ between the lights and from the refractive index n_{w} and the thickness d of the optical guide layer 20 at which the sensitivity of the light receiving device is maximized. As a result, the incident direction of the light can be determined.

The optical scanning device and the light receiving device according to the embodiments of the present disclosure can be utilized in applications to, for example, the LiDAR system mounted on vehicles such as a car, a UAV, and an AGV.

What is claimed is:

1. An optical device comprising:
a first structure body with a first surface;
a second structure body with a second surface facing the first surface;
one or more optical guide regions positioned between the first surface of the first structure body and the second surface of the second structure body, the one or more optical guide regions including a liquid crystal material; and
a first alignment film disposed on the first surface and aligning the liquid crystal material, the first alignment film being a rubbing alignment film,
wherein the optical device further comprises a second alignment film that is an optical alignment film formed by irradiation with polarized light.

2. The optical device according to claim 1,
wherein the second alignment film is a film containing a material that is bonded to the second surface through a siloxane bond interposed therebetween.

3. The optical device according to claim 2,
wherein the film is a monomolecular film.

4. The optical device according to claim 1,
wherein the second surface has one or more recesses with a depth of greater than or equal to 1 μm and smaller than or equal to 10 μm, and
the liquid crystal material fills the one or more recesses.

5. The optical device according to claim 4,
wherein the one or more recesses are multiple recesses,
the one or more optical guide regions are multiple optical guide regions, and
the multiple optical guide regions include the multiple recesses in one-to-one correspondence.

6. The optical device according to claim 1,
wherein the first surface is a flat surface or an uneven surface with a difference in height of less than 1 μm, and
the liquid crystal material covers the flat surface or the uneven surface.

7. The optical device according to claim 1,
wherein the first structure body includes a first mirror having the first surface, and
the second structure body includes a second mirror having the second surface.

8. The optical device according to claim 7,
wherein the first mirror and the second mirror are each formed of a dielectric multilayer film.

9. The optical device according to claim 8,
wherein the first mirror has a higher light transmittance than the second mirror.

10. The optical device according to claim 9,
wherein the first structure body includes a first electrode,
the second structure body includes a second electrode facing the first electrode,
the one or more optical guide regions are positioned between the first electrode and the second electrode, and
a direction of light emitted from the one or more optical guide regions through the first structure body or an incident direction of light taken into the one or more optical guide regions through the first structure body is changed by changing a voltage applied between the first electrode and the second electrode.

11. The optical device according to claim 1, further comprising:
phase shifters connected to the one or more optical guide regions directly or through other waveguides.

12. The optical device according to claim 1,
wherein the one or more optical guide regions are multiple optical guide regions, and
the optical device further comprises multiple phase shifters connected to the multiple optical guide regions directly or through other waveguides in one-to-one correspondence.

13. An optical detection system comprising:
the optical device according to claim 1,
an optical detector that detects light emitted from the optical device and reflected from an object; and
a signal processing circuit that creates distance distribution data based on outputs of the optical detector.
